(19) United States
(12) Patent Application Publication
(10) Pub. No.: US 2006/0269222 A1
(43) Pub. Date: Nov. 30, 2006

(54) BROADCAST RECORDING AND REPRODUCTION APPARATUS

(75) Inventor: Yuki HORII, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/421,146

(22) Filed: May 31, 2006

Related U.S. Application Data
(60) Provisional application No. 60/685,379, filed on May 31, 2005.

(51) Int. Cl. H04N 5/91

(52) U.S. Cl. 386/83

(57) ABSTRACT

A conventional technique to accumulate a content and reproduce the accumulated content makes wasteful use of a recording area, since an application included in the accumulated content is not deleted from the recording area even after the expiration date of its certificate has passed and the application has thus become non-executable. Furthermore, when the application is executed at the time of reproducing the content, such technique wastefully performs authentication of the non-executable application with an expired certificate. The present invention provides a mechanism for authenticating a certificate of an application at the time of accumulating a content and not recording an application whose authentication has failed, as well as a mechanism for deleting, from a recording area, an application with an expired certificate in an already recorded content.

### CROSS REFERENCE TO RELATED APPLICATION

This application claims the benefit of U.S. Provisional Application No. 60/685379, filed May 31, 2005, the contents of which are herein incorporated by reference in its entirety.

### BACKGROUND OF THE INVENTION

(1) Field of the Invention

The present invention relates to a recording and reproduction apparatus which accumulates a content and reproduces the accumulated content. In particular, the present invention relates to a setup for receiving a content made up of video, audio, and data such as a program that are multiplexed, with a broadcast wave in synchronization with one another and sent, receiving the broadcast wave and accumulating the video, audio, and data, as well as a setup for reproducing the content while maintaining synchronization among the video, audio and data such as a program.

(2) Description of the Related Art

Various contents are included in a broadcast wave sent from a broadcast station. Aside from video and audio used in a normal TV show, there are cases where data is included in the contents. There are several methods for sending the data, which can be roughly divided into a method of sending the data chronologically and a method of repeatedly sending the data per set interval. In the former method of sending the data chronologically, for example, data that continues is sent in sequential order over the course of time. This method is suitable for sending large amounts of data over a long period of time, but there is a drawback in that data that could not be received at the timing of sending cannot be received again. On the other hand, in the later method of repeatedly sending the data at a set interval, the same data is repeatedly sent for a number of times during a fixed period. This method has an advantage in that during the period when the same data is being sent, any one of the repeatedly-sent pieces of data can be received, and thus the timing of receiving is not limited. Data broadcast, represented by BML, and file sending through DSMCC data carousel are examples of this method. It is unknown, particularly in broadcast, when a recipient will select a channel and commence reception. In the method of sending the data chronologically, when the start of reception falls behind the sending and acquisition of the data fails, the data cannot be re-acquired. Therefore, when sending data such as an application program along with video and audio in the broadcast wave, the method of repeatedly sending the data per set interval is favorable.

At present, specifications for receiving a broadcast wave that includes video, audio, and an application program and executing the application program in synchronization with the video and audio, as in the above method, have been developed and are in operation. It is possible to receive the sent application program, load the application program into a terminal, and implement various extra functions by executing the application program, rather than simply viewing the video and audio. This method of sending the application program and loading the application program into the terminal is also called “downloading”. For example, a specification called Digital Video Broadcasting-Multimedia Home Platform (DVB-MHP) ETSI ES 201812 V1.1.1 (2003-12) has been developed in Europe, and operations according to this specification have already commenced. In addition, Open Cable Application Platform (OCAP) OC-SP-OCAP1.0-I14-050119 specification, which provides the same setup in the cable broadcast environment, is being developed in the United States, and actual operations are set to commence. In these specifications, the application program is written in the Java language. Various Application Programming Interfaces (APIs) for tuning, graphics display, and the like are provided in the terminal, and a Java application program can control those functions by calling the APIs.

In addition, in North America, the OCAP-DVR OC-SP-OCAP-DVR-I01-040524 specification, which is aimed at adding a function for recording and reproducing the contents to the OCAP specification, is being developed. With this specification, the video, audio, and a Java application program executed in synchronization with them, which are sent as a cable television broadcast, are recorded as contents, and furthermore, are reproduced in the same manner as when the recorded contents are directly reproduced from the broadcast wave. The application program is reproduced in synchronization with the video and audio, in the same manner as direct reproduction from the broadcast wave.

Moreover, with OCAP-DVR, trick-play of the contents is realized by recording broadcast contents into a high-speed random-accessible recording medium, such as a hard disk, a semiconductor memory, and the like. Here, the trick-play refers to functions for reproducing the contents at an arbitrary speed, from an arbitrary position, and so on, such as fast-forward, rewind, slow-motion, pause, skip, and the like. With OCAP-DVR, the application program loaded into the terminal from the broadcast wave can control the recording and trick-play of the contents. In other words, APIs for recording and trick play are provided in the terminal, and a Java application program controls each function by calling those APIs.

Usually, control information for synchronization is previously multiplexed in a broadcast wave so that an application program can be executed in synchronization with the video and audio. Application programs are sequentially executed and terminated according to their respective synchronization control information. This makes it possible to switch to an appropriate application program and execute it depending on a specific scene of the video and audio. Meanwhile, in the case where a content recorded by a terminal according to OCAP-DVR or the like is reproduced by means of trick-play, it is necessary to switch to an appropriate application program depending on the status of the trick-play. For example, in the case where a video image has switched to another through fast-forward, an application program synchronously associated with To the video image is to be switched to another in accordance with the reproduction speed of the video. Meanwhile, in the case where the video is reproduced by means of skip-play, an application program which is synchronized with a reproduction start position in the video after the skip-play, is executed.

However, a conventional technique to accumulate a content and reproduce the accumulated content makes wasteful use of a recording area, since an application included in the accumulated content is not deleted from the recording area even after the expiration date of its certificate has passed and the application has thus become non-executable. Furthermore, when the application is executed at the time of reproducing the content, such technique wastefully performs authentication of the non-executable application with an expired certificate (for example, refer to Japanese Laid-Open Patent Application No. 10-155140).

In view of the above, the present invention provides a mechanism for authenticating a certificate of an application at the time of accumulating a content and not recording an application whose authentication has failed, as well as a mechanism for deleting, from a recording area, an application with an expired certificate in an already recorded content.

With these mechanisms, it is an object of the present invention to: make an effective use of a recording area by reducing wasteful use of a recording area, which is caused by recording a Java program to be no longer activated; and reduce the time required to activate a Java program by reducing the waste of authenticating a Java program with an expired certificate.

### SUMMARY OF THE INVENTION

In order to achieve the above object, the broadcast recording and reproduction apparatus of the present invention is a broadcast recording and reproduction apparatus that receives a broadcast wave, which includes video information, audio information, an application program, and a certificate corresponding to the application program, and records and reproduces the received broadcast wave, the apparatus including: a recording unit that records, into a recording area, the video information, the audio information; and the application program included in the received broadcast wave; an authentication unit that authenticates the application program included in the broadcast wave, using the certificate corresponding to the application program; an expiration date management unit that holds an expiration date of the certificate corresponding to the application program included in the broadcast wave, and compares a current time with the expiration date of the certificate corresponding to the application program; an application deletion unit that deletes, from the recording area, the application program recorded in the recording area, in the case where a result of the comparison performed by the expiration date management unit indicates that the current time has passed the expiration date of the certificate corresponding to the application program; and a broadcast wave reproduction unit that reproduces the video information, the audio information, and the application program included in the broadcast wave recorded in the recording area.

With this structure, it becomes possible to make an effective use of the recording area by reducing wasteful use of the recording area, which is caused by recording an application program such as a Java program to be no longer activated, since the application program with an expired certificate is deleted from the recording area. Furthermore, it becomes possible to reduce the waste of authenticating an application program such as a Java program with an expired certificate, and thus to shorten the time required to activate the Java program.

Moreover, the recording unit may record, into the recording area, the video information and the audio information included in the broadcast wave, in the case where a result of the authentication performed by the authentication unit indicates failure.

With this structure, it becomes possible to make a further effective use of the recording area since only the video information and the audio information are recorded into the recording area without recording the application program, for example, in the case where the result of the authentication indicates failure.

Moreover, the recording unit may include: a first recording control unit that records, into a recording area of a first recording medium, the video information, the audio information, and the application program included in the received broadcast wave; and a second recording control unit that dubs, onto a recording area of a second recording medium, the video information, the audio information, and the application program recorded in the recording area of the first recording medium, the second recording medium being different from the first recording medium, wherein in the case where the expiration date of the certificate, held by the expiration date management unit, corresponding to the application program to be dubbed has passed, the second recording control unit may dub, onto the recording area of the second recording medium, the video information and the audio information out of the video information, the audio information, and the application program to be dubbed, which are recorded in the recording area of the first recording medium.

With this structure, it becomes possible to make an effective use of the recording area of the second recording medium since only the video information and the audio information are dubbed onto the recording area of the second recording medium without dubbing the application program corresponding to the expired certificate, for example, in the case where the dubbing is performed.

Moreover, in the case where the expiration date of the certificate, held by the expiration date management unit, corresponding to the application program to be dubbed has passed, the application deletion unit may delete the application program to be dubbed, which is recorded in the recording area of the first recording medium.

With this structure, it becomes possible to make an effective use of the recording area of the first recording medium since the application program corresponding to the expired certificate is deleted from the recording area of the first recording medium, for example, in the case where the dubbing is performed.

Moreover, the expiration date management unit may: hold the expiration date of the certificate corresponding to the application program included in the broadcast wave, when the application program included in the broadcast wave is recorded; and compare the current time with the held expiration date of the certificate corresponding to the application program at regular time intervals.

With this structure, it becomes possible to always make an effective use of the recording area since an expired application program is deleted by regularly checking the expiration dates of application programs.

Moreover, the expiration date management may: hold the expiration date of the certificate corresponding to the application program included in the broadcast wave, when the broadcast wave is recorded; and perform the comparison in the case where there is not enough free space in the recording area.

With this structure, it becomes possible to make an effective use of the recording area according to need.

Note that the present invention can be implemented not only as the above-mentioned broadcast recording and reproduction apparatus but also as a broadcast recording and reproduction method, a program for the method and a storage medium for storing the program.

### FURTHER INFORMATION ABOUT TECHNICAL BACKGROUND TO THIS APPLICATION

The disclosure of U.S. Provisional Application No. 60/685379, filed May 31, 2005, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a structure of a broadcast system according to the present invention;

FIG. 2 is a diagram showing an example of how to use a frequency band used in communications between a system on the broadcast system side and a terminal apparatus, in a cable television system according to the present invention;

FIG. 3 is a diagram showing an example of how to use a frequency band used in communications between a system on the broadcast system side and a terminal apparatus, in a cable television system according to the present invention;

FIG. 4 is a diagram showing an example of how to use a frequency band used in communications between a system on the broadcast system side and a terminal apparatus, in a cable television system according to the present invention;

FIG. 5 is a diagram showing a structure of a TS packet predefined by MPEG-2 specifications;

FIG. 6 is a schematic diagram of an MPEG-2 transport stream;

FIG. 7 is a diagram showing an example of division when a PES packet predefined by MPEG-2 specifications is carried in TS packets;

FIG. 8 is a diagram showing an example of division when an MPEG-2 section predefined by MPEG-2 specifications is carried in TS packets;

FIG. 9 is a diagram showing a structure of an MPEG-2 section predefined by MPEG-2 specifications;

FIG. 10 is a diagram showing an example of use of an MPEG-2 section predefined by MPEG-2 specifications;

FIG. 11 is a diagram showing an example of use of a PMT predefined by MPEG-2 specifications;

FIG. 12 is a diagram showing an example of use of a PAT predefined by MPEG-2 specifications;

FIG. 13 is a diagram showing a configuration example of a hardware configuration of a broadcast recording and reproduction apparatus according to the present invention;

FIG. 14 is a diagram showing an example of a front panel of an input unit in a hardware configuration of a terminal apparatus according to the present invention;

FIG. 15 is a diagram showing an example of a device connection at the time of recording, in the recording and reproduction apparatus according to the present invention;

FIG. 16 is a diagram showing an example of a device connection at the time of reproduction, in the recording and reproduction apparatus according to the present invention;

FIG. 17 is a diagram showing a structure of a program stored in a terminal apparatus according to the present invention;

FIG. 18 is a diagram showing an example of an EPG executed by a terminal apparatus according to the present invention;

FIG. 19 is a diagram showing an example of an EPG executed by a terminal apparatus according to the present invention;

FIG. 20 is a diagram showing an example of information stored in a secondary storage unit according to the present invention;

FIG. 21 is a diagram showing an example of a record information management table according to the present invention;

FIG. 22 is a schematic diagram showing the details of an AIT specified in the DVB-MHP standard according to the present invention;

FIG. 23 is a schematic diagram showing a file system that is transmitted in the DSMCC format according to the present invention;

FIG. 24 is a diagram showing an example of an AIT according to the present invention;

FIG. 25 is a diagram showing an example of information stored in the secondary storage unit according to the present invention;

FIG. 26 is a diagram showing an example of files that include hash values of files or directories according to the present invention;

FIG. 27 is a diagram showing a structure of a certificate chain according to the present invention;

FIG. 28 is a diagram showing a structure of an X.509 certificate according to the present invention;

FIG. 29 is a diagram showing a structure of a signature file according to the present invention;

FIG. 30 is a conceptual rendering which represents a physical connection sequence, processing details, and input/output data format of each device according to the present invention;

FIG. 31 is a diagram showing an example of an expiration management table according to the present invention;

FIG. 32 is a diagram showing detailed constituent elements of a security manager according to the present invention;

FIG. 33 is a flowchart showing an example of processes to be performed when a service recording unit of the present invention makes a service pre-recording notification;

FIG. 34 is a flowchart showing an example of processes to be performed when an expiration check request issue unit of the present invention issues an expiration check request;

FIG. 35 is a block diagram showing a general hardware configuration of the broadcast recording and reproduction apparatus according to the present invention;

FIG. 36 is a diagram showing an example of a record information management table according to the present invention;

FIG. 37 is a conceptual rendering which represents a physical connection sequence, processing details, and input/output data format of each device according to the present invention;

FIG. 38 is a conceptual rendering which represents a physical connection sequence, processing details, and input/output data format of each device according to the present invention;

FIG. 39 is a flowchart showing an example of processes to be performed when the service recording unit of the present embodiment makes a service pre-recording notification; and

FIG. 40 is a flowchart showing an example of processes to be performed when the expiration check request issue unit of the present invention issues an expiration check request.

### DESCRIPTION OF THE PREFERRED EMBODIMENTS

In order to solve the above problem, the present invention is a broadcast recording and reproduction apparatus that receives a broadcast wave, which is made up of one or more video/audio as well as one or more applications, each having a certificate, and records and reproduces the broadcast wave, the broadcast recording and reproduction apparatus including: a recording unit that records the received broadcast wave; an authentication unit that authenticates an application included in the broadcast wave, using the certificate of the application, when the broadcast wave is recorded and reproduced; an expiration date management unit that holds an expiration date of the certificate of the application included in the broadcast wave when the broadcast wave is recorded, and regularly compares the expiration date of the certificate of the application with a current time; an application deletion unit that deletes the application from a recording area in the case where a result of the comparison performed by the expiration date management unit indicates that the current time has passed the expiration date of the certificate of the application; and a broadcast wave reproduction unit that reproduces the recorded broadcast wave.

With this structure, it is possible to delete an application with an expired certificate from the recording area and thus to reduce wasteful use of the recording area.

### First Embodiment

Hereafter, an apparatus and a method according to the first embodiment of the present invention are described with reference to the drawings. The present invention is directed to recording and reproduction of sent and received contents with an arbitrary medium; however, in the present embodiment, a cable television broadcast system is described as an example. In the cable television broadcast system, a broadcast recording and reproduction apparatus of the present invention is generally called a terminal apparatus.

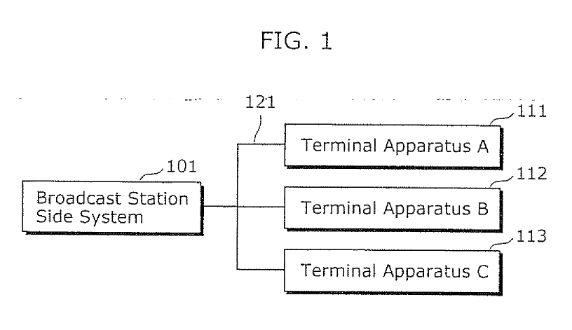

FIG. 1 is a block diagram showing a relationship of apparatuses that make up a broadcast system. The broadcast system is made up of a broadcast station side system 101, and three terminal apparatuses: a terminal apparatus A111, a terminal apparatus B112, and a terminal apparatus C113. A coupling 121 between the broadcast station side system and each terminal apparatus is, in the cable system, a wired coupling such as a coaxial cable, a fiber-optic cable, and the like. In FIG. 1, one broadcast station side system is coupled with three terminal apparatuses, but the number of terminal apparatuses is arbitrary.

The broadcast station side system 101 sends information such as video/audio/data for data broadcast in a broadcast signal to a plurality of terminal apparatuses. The broadcast signal is transmitted using a frequency within a frequency band set by an operation regulations of the broadcast system, the laws of a country/region in which the broadcast system is operated, and so on.

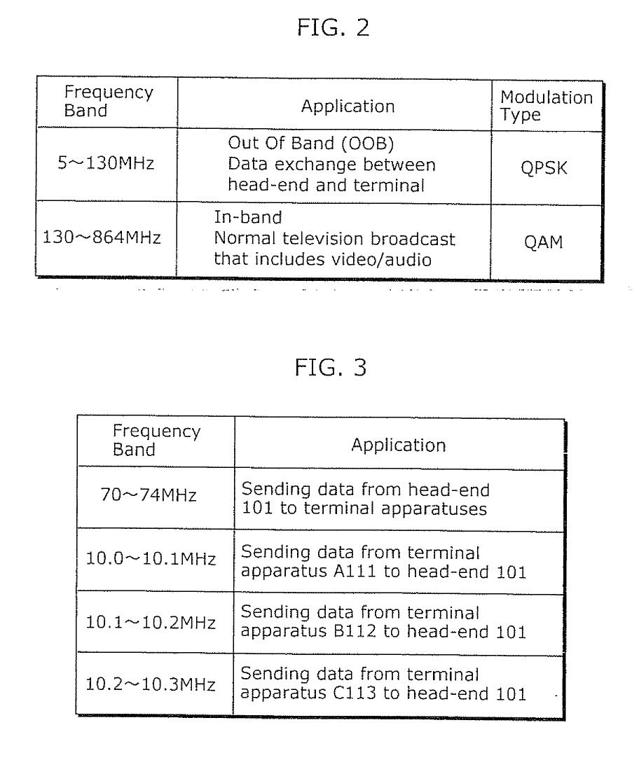

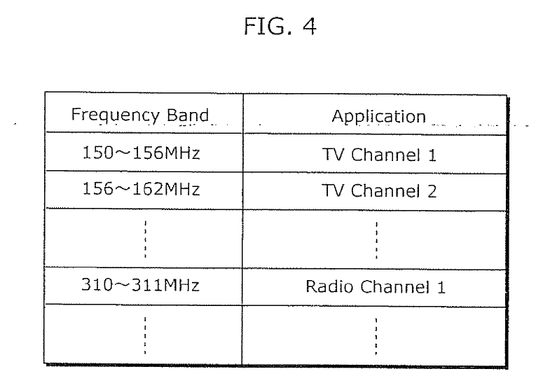

In the cable system according to the present embodiment, frequency bands are divided for use of broadcast signal transmission, based on the data details and direction of signal transmission (inbound, outbound). FIG. 2 is a chart indicating one example of the division of the frequency band. The frequency band is roughly divided into two types: Out Of Band (abbr. OOB) and In-Band. 5 MHz to 130 MHz is allocated as OOB, and is mainly used in inbound/outbound data exchange between the broadcast station side system 101 and the terminal apparatus A111, the terminal apparatus B112, and the terminal apparatus C113. 130 MHz to 864 MHz is allocated as In-Band, and is mainly used in an outbound-only broadcast channel that includes video/audio. QPSK is employed for OOB, whereas QAM64 or QAM256 is employed for In-Band as modulation techniques. The modulation techniques are generally known and of little concern to the present invention, and therefore detailed descriptions are not repeated. FIG. 3 is one example of a more detailed use of the OOB frequency band. 70 MHz to 74 MHz is used in outbound data sending from the broadcast station side system 101, and all of the terminal apparatus A111, the terminal apparatus B112, and the terminal apparatus C113 receive the same data from the broadcast station side system 101 On the other hand, 10.0 MHz to 10.1 MHz is used in inbound data sending from the terminal apparatus A111 to the broadcast station side system 101; 10.1 MHz to 10.2 MHz is used in inbound data sending from the terminal apparatus B112 to the broadcast station side system 101; and 10.2 MHz to 10.3 MHz is used in inbound data sending from the terminal apparatus C113 to the broadcast station side system 101. Through this, it is possible to independently send data unique to each terminal apparatus from each terminal apparatus A111, 8112, and C113 to the broadcast station side system 101. FIG. 4 shows an example use of the In-Band frequency band. Frequency bands of 150 MHz to 156 MHz and 156 MHz to 162 MHz are allocated respectively to a television channel 1 and a television channel 2, and the subsequent frequencies are allocated to television channels at 6 MHz intervals. Radio channels are allocated in 1 MHz units from 310 MHz on. Each of these channels may be used as analog broadcast or as digital broadcast. Digital broadcast is sent in TS packet format under the MPEG-2 specification, and it is also possible to send data for various data broadcast and TV show composition information for configuring EPG, in addition to audio and video.

The broadcast station side system 101 has a QPSK modulation unit, a QAM modulation unit, and so on to send an appropriate broadcast signal to the terminal apparatuses, using the frequency bands described above. In addition, the broadcast station side system 101 has a QPSK demodulator for receiving data from the terminal apparatuses. Moreover, it is conceivable that the broadcast station side system 101 has various devices related to these modulation units and the demodulation unit. However, a detailed description of them is not repeated here, since the present invention is mainly related to the terminal apparatuses.

Meanwhile, the terminal apparatus A111, terminal apparatus B112, and terminal apparatus C113 have a QAM demodulation unit and a QPSK demodulation unit in order to receive and reproduce a broadcast signal from the broadcast station side system 101. In addition, each terminal apparatus has a QPSK modulation unit in order to send their unique data to the broadcast station side system 101. In the present invention, the terminal apparatuses are broadcast recording and reproduction apparatuses, and their detailed configurations are described later.

The broadcast station side system 101 modulates an MPEG-2 transport stream and transmits a broadcast signal that carries the resulting transport stream. Each of the terminal apparatuses receive the broadcast signal, demodulates the broadcast signal to obtain the original MPEG-2 transport stream, and extracts necessary information from the transport stream for use. In order to describe a device function and connection structure present in the terminal apparatuses, the structure of the MPEG-2 transport stream is first described in a simple manner.

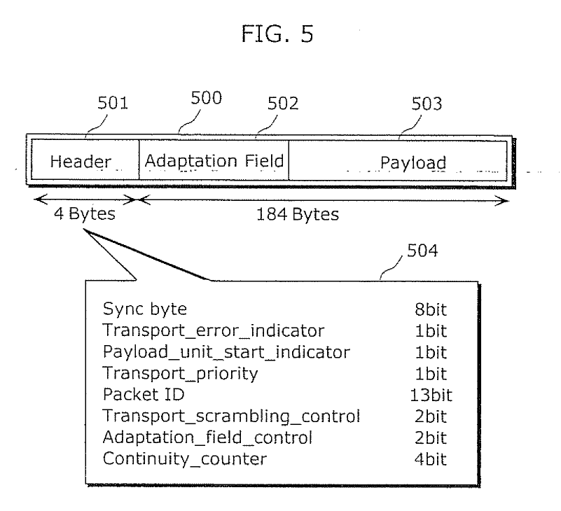

FIG. 5 is a diagram showing the structure of a TS packet. A TS packet 500, which is 188 byte-long, is made up of a header 501, an adaptation field 502, and a payload 503. The header 501 holds control information for the TS packet. The header 501, which is 4-byte long, has a structure represented as 504. The header 501 includes a field described as a “Packet ID (hereinafter referred to as “PID”)” whose value is used to identify this TS packet. The adaptation field 502 holds additional information such as time information. Note that the adaptation field 502 is not an integral constituent element and therefore that there is a case where no adaptation field is included in a TS packet. The payload 503 holds information to be carried in the TS packet, such as video/audio data or data used for data broadcast.

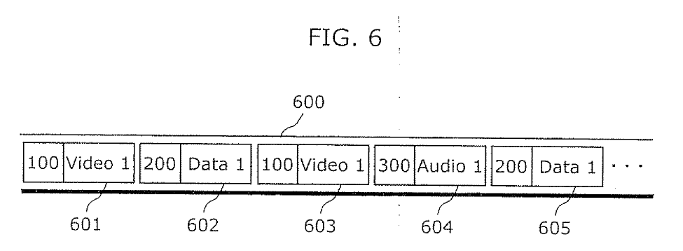

FIG. 6 is a schematic diagram showing an MPEG-2 transport stream. TS packets hold various information in their payloads, such as video, audio, data used for data broadcast, and the like. A TS packet 601 and a TS packet 603 hold a PID 100 in the header, and hold information regarding video 1 in the payload. A TS packet 602 and a TS packet 605 hold a PID 200 in the header, and hold information regarding data 1 in the payload. A TS packet 604 holds a PID 300 in the header, and holds information regarding audio 1 in the payload. Mixing TS packets which hold various types of data in the payloads and transmitting these as a series in sequence is called multiplexing. An MPEG-2 transport stream 600 is one example of a configuration in which the TS packets 601 to 605 are multiplexed.

TS packets that have identical PIDs hold identical types of information. Therefore, the terminal apparatus reproduces video and audio, and reproduces data such as TV show composition information, by receiving the multiplexed TS packets and extracting, per PID, the information that each of the TS packets holds. In FIG. 6, the TS packet 601 and the TS packet 603 each carry information regarding the video 1, and the TS packet 602 and the TS packet 605 each carry information regarding the data 1.

Here, description is given regarding a format of each type of data contained in the payload.

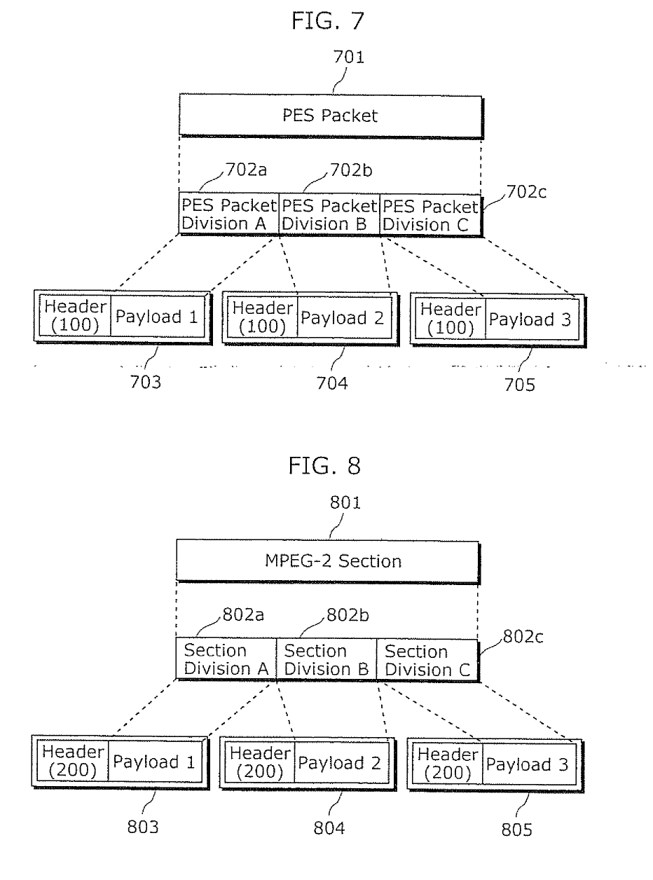

Video and audio are represented by a format called a Packetized Elementary Stream (PES) packet. A PES packet includes video information or audio information of a certain time period, and by receiving the PES packet, the broadcast recording and reproduction apparatus can output the video/audio information contained in that PES packet to a screen/speaker. The broadcast station transmits PES packets without pause, and therefore it is possible for the broadcast recording and reproduction apparatus to continuously reproduce the video and audio without pause. When actually transmitted, a PES packet is divided and stored in the payloads of a plurality of TS packets in the case where the PES packet has a size larger than the payload of one TS packet. FIG. 7 shows an example of how a PES packet is divided when it is transmitted. A PES packet 701 is too large to be stored and carried in the payload of a single TS packet, and therefore the PES packet 701 is divided into a PES packet division A702a, a PES packet division B702b, and a PES packet division C702c, and is transmitted in three TS packets 703 to 705 which have an identical PID. In actuality, the video and the audio are obtained as elementary streams (ESs) that are obtained by concatenating data contained in the payloads of a plurality of PES packets. These elementary streams are in the format of digitalized video and audio, such as defined by the MPEG-2 Video standard, the MPEG-1 and 2 Audio standard, and the like.

On the other hand, information such as the TV show composition information and data used for data broadcast is expressed using a format called MPEG-2 section. When actually transmitted, an MPEG-2 section is divided and stored in the payloads of a plurality of TS packets in the case where the MPEG-2 section has a size larger than the payload of one TS packet. FIG. 8 shows an example of how an MPEG-2 section is divided when it is transmitted. As an MPEG-2 section 801 is too large to be stored and transmitted in a payload of a single TS packet, and therefore the MPEG-2 section 801 is divided into a section division A 802a, a section division B 802b, and a section division C 802c, and is transmitted in three TS packets 803 to 805 which have an identical PID.

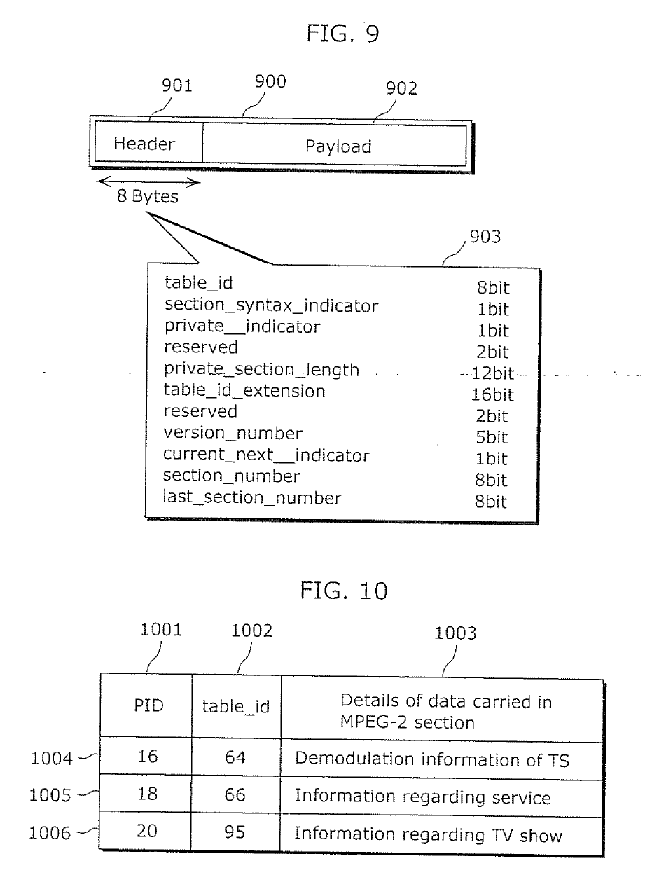

FIG. 9 expresses a structure of an MPEG-2 section. An MPEG-2 section 900 is configured of a header 901 and a payload 902. The header 901 holds control information for this MPEG-2 section. The breakdown of this header 901 is represented as shown as a header structure 903. The payload 902 holds data to be carried in the MPEG-2 section 900. In the header structure 903, table_id represents the type of the MPEG-2 section and table_id_extension is an extension identifier that is used to distinguish this MPEG-2 section from other MPEG-2 sections with the identical table_id. FIG. 10 shows an example use of MPEG-2 sections in the case where TV show composition information is transmitted. In this example, as described in a row 1004, information that is required to demodulate a broadcast signal is carried in an MPEG-2 section whose table_id in the header structure 903 is 64, and such MPEG-2 section is carried in TS packets with the PID of 16.

The PES format does not exist in the case of MPEG-2 sections. For that reason, an elementary stream (ES) is a concatenation of the payloads of TS packets identified by an identical PID within the MPEG-2 transport stream. For example, in FIG. 8, the TS packets 803 to 805, which carry the MPEG-2 section 801 in segment, are all identified with the PID of 200. It can be said that this is an ES which carries the MPEG-2 section 801.

A concept called a program further exists in the MPEG-2 transport stream. The program is expressed as a collection of ESs, and is used in the case where handling a plurality of ESs all together is desirable. The use of a program makes it possible to handle video and audio, as well as data used for data broadcast that accompanies such video and audio in a collective manner. For example, in the case of collectively handling the video and audio to be reproduced simultaneously, by grouping the video ES and the audio ES as a program, it can be seen that the broadcast recording and reproduction apparatus should simultaneously reproduce these two ESs as one TV show.

To express the program, two tables, called a Program Map Table (PMT) and a Program Association Table (PAT) are used in MPEG-2. Refer to ISO/IEC13818-1, the “MPEG-2 Systems” specification for details about these tables. The PMT and the PAT are briefly described hereafter.

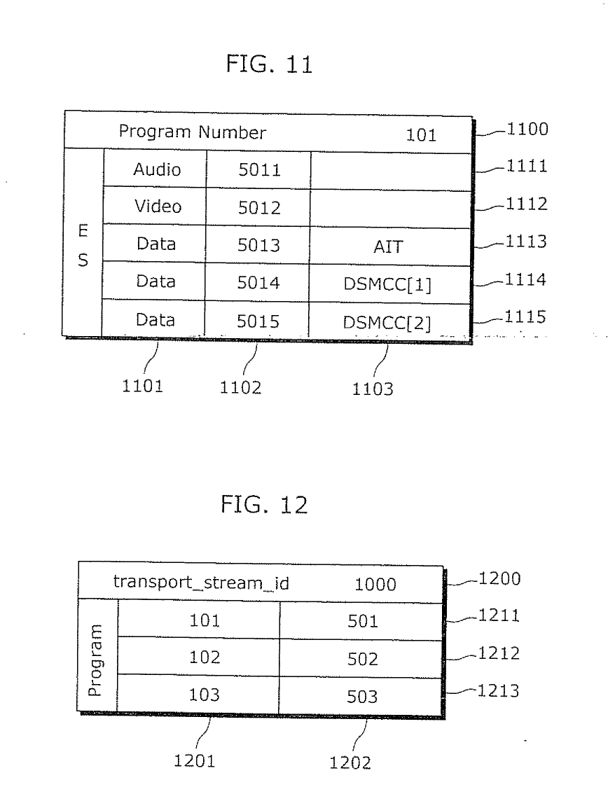

The PMT is a table included in the MPEG-2 transport stream, in a number as many as that of programs. The PMT is configured as an MPEG-2 section, and has a table_id of 2. The PMT holds a program number used in identifying the program and additional information of the program, as well as information regarding ESs belonging to the program. An example of the PMT is given in FIG. 11. 1100 is a program number. The program number is assigned uniquely to each program in the same transport stream, and is used in identifying the PMT. Rows 1111 to 1115 express information regarding individual ESs. A column 1101 describes the types of ESs, is in which “video”, “audio”, “data”, and so on are specified. A column 1102 describes the PIDs of TS packets constituting the respective ESs. A column 1103 describes additional information regarding the respective ESs. For example, the ES shown in the row 1111 is an audio ES, and is carried in TS packets with a PID of 5011.

Only one PAT is included in an MPEG-2 transport stream. The PAT is configured as an MPEG-2 section, has a table_id of 0, and is carried in TS packets with a PID of 0. The PAT holds a transport_stream_id used in identification of the MPEG-2 transport stream, and information regarding all PMTs that represent programs existing in the MPEG-2 transport stream. An example of the PAT is given in FIG. 12. 1200 is a transport_stream_id. The transport_stream_id is used in identifying the MPEG-2 transport stream. Rows 1211 to 1213 express information regarding the respective programs. A column 1201 describes respective program numbers. A column 1202 describes the PIDs of TS packets which carry the PMTs that correspond to the respective programs. For example, the PMT of the program shown in a row 1211 has a program number of 101, and the corresponding PMT is carried in TS packets with a PID of 501.

In the case where the terminal apparatus reproduces a certain program, the terminal apparatus uses the PAT and the PMT to specify the video and audio that make up the program, and reproduces that video and audio. For example, in regards to the MPEG-2 transport stream that carries the PAT in FIG. 12 and the PMT in FIG. 11, the following procedure is followed in the case where the video and audio belonging to the program with a program number of 101 are reproduced. First, a PAT transmitted as an MPEG-2 section with a table_id of “0” is acquired from TS packets with a PID of “0”. The PAT is searched for a program with the program number “101”, and the row 1211 is obtained. From the row 1211, the PID “501” of the TS packets which carry the PMT of the program with a program number “101”, is obtained. Next, the PMT transmitted as the MPEG-2 section with a table_id of “2” is acquired from TS packets with the PID of “501”. The row 1111, which describes audio ES information, and the row 1112, which describes video ES information, are obtained from the PMT. A PID “5011” of TS packets which carry the audio ES is obtained from the row 1111. In addition, a PID “5012” of TS packets which carry the video ES is obtained from the row 1112. Next, an audio PES packet is acquired from the TS packets with a PID “5011”, and a video PES packet is acquired from the TS packets with a PID of “5012”. Through this, it is possible to acquire the video and audio ES packets to be reproduced, and thus to reproduce the video and audio making up the program with the program number 101.

Note that there are cases where the MPEG-2 transport stream is scrambled. This is a setup called conditional access system. For example, by scrambling the PES packets which carry certain video/audio information, only specified viewers who can descramble them are able to view that video and audio. In order to descramble and view the video and audio, a viewer must descramble them using a device called a descrambler. For example, in an OCAP-compatible terminal apparatus, a card-form adapter with an internal descrambler is used. A cable television operator distributes an adapter configured to be able to descramble a specified program to each viewer, and the viewer inserts that adapter into the terminal apparatus. Upon doing so, the adapter descrambles the specified program based on descrambling information such as a descrambling key and contract information of each contract holder. A method of descrambling, a method of obtaining the descrambling key, and the like depend on the adapter, and have no influence on the realization of the present invention.

Thus far, simple descriptions regarding the MPEG-2 specifications have been given; hereafter, detailed definitions of terminology are given. In the present invention, two types of the term “program” exist. One is a “program” which appears in the MPEG-2 specifications, and the other is a “program” referring to an assemblage of codes executed by a CPU. As the former is synonymous with the term “service” used in the operation regulations, hereafter, to avoid confusion, the former is called “service” and the latter is called simply “program”. Furthermore, concerning the latter, a “program” particularly written in the Java language is called a “Java program”.

Description has been given regarding several kinds of general information specified in the MPEG-2 specifications according to the present invention. Hereafter, the broadcast recording and reproduction apparatus used in the present embodiment is described in detail.

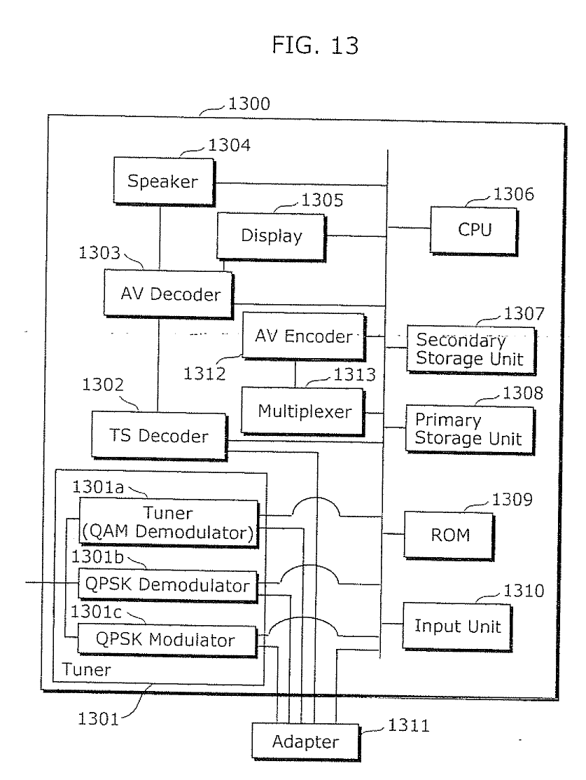

FIG. 13 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is the broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; and a multiplexer (MPEG-2 Transport Stream Multiplexer or the like) 1313. Note that the present embodiment is obtained by expanding a broadcast recording and reproduction terminal implemented by the OCAP-DVR specifications, and the basic hardware configuration is nearly identical to that required by the OCAP-DVR specifications.

The tuner 1301 is a device which demodulates a broadcast signal modulated by and transmitted from the broadcast station side system 101, in accordance with tuning information including a frequency prescribed by the CPU 1306. An MPEG-2 transport stream obtained as a result of the demodulation performed by the tuner 1301 passes through the adapter 1311 that has a descrambling function, and is sent to the TS decoder 1302.

The TS decoder 1302 is a device which has a function to segregate PES packets and MPEG-2 sections which comply with specified conditions from the MPEG-2 transport stream, based on a PID, a section filter condition, and so on prescribed by the CPU 1306. In the case where a broadcast is received and a service is reproduced without recording, the MPEG-2 transport stream which the adapter 1311 outputs is inputted to the TS decoder 1302. On the other hand, in the case where a service recorded in the secondary storage unit 1307 is reproduced, the MPEG-2 transport stream which the secondary storage unit 1307 outputs is inputted to the TS decoder 1302. Which input to receive is controlled by the CPU 1306.

The PES packets of the video and audio which the TS decoder 1302 segregated are outputted to the AV decoder 1303. In addition, the MPEG-2 sections segregated by the TS decoder 1302 are transferred to the primary storage unit 1308 through Direct Memory Access (DMA), and are used by a program executed by the CPU 1306.

The AV decoder 1303 is a device with a function to decode the encoded video ES and audio ES. The AV decoder fetches the ESs from the PES packets that carry the audio and video information transferred from the TS decoder, and decodes the ESs. An audio signal and a video signal obtained through the decoding performed by the AV decoder 1303 are outputted to the speaker 1304 and the display 1305 at the time of service reproduction, but are outputted to the AV encoder 1312 at the time of service recording. Which output route to take is controlled by the CPU 1306 according to a user instruction.

The speaker 1304 reproduces audio outputted from the AV decoder 1303.

The display 1305 reproduces video outputted from the AV decoder 1303.

The CPU 1306 executes a program that operates in the broadcast recording and reproduction apparatus. The CPU 1306 executes a program contained in the ROM 1309. Or, the CPU 1306 also executes a program downloaded from a broadcast signal or a network and held in the primary storage unit 1308. Or, the CPU also executes a program downloaded from a broadcast signal or a network and held in the secondary storage unit 1307. The CPU 1306 controls the tuner 1301, TS decoder 1302, AV decoder 1303, speaker 1304, display 1305, secondary storage unit 1307, primary storage unit 1308, ROM 1309, input unit 1310, adapter 1311, AV encoder 1312, and multiplexer 1313 in accordance with the instructions of the executed program. In addition, the CPU 1306 is capable of controlling the adapter 1311 by communicating not only with devices present within the terminal apparatus 1300, but with the devices within the adapter 1311.

The secondary storage unit 1307 is a memory apparatus, the memory of which is not deleted even if the power supply to the device is interrupted; for example, the secondary storage unit 1307 is configured of a device in which information is not deleted even when the terminal apparatus 1300 is powered off, such as a nonvolatile memory like a FLASH-RON, a Hard Disk Drive (HDD), a rewritable medium like a CD-R and a DVD-R. The secondary storage unit 1307 saves information based on an instruction from the CPU 1306.

The primary storage unit 1308 is a device which has a function for temporarily saving information in accordance with an instruction from the CPU 1306, a DMA transfer-capable device, and so on, and is configured of a RAM or the like.

The ROM 1309 is a non-rewriteable memory device, and to be more specific, is configured of a ROM, a CD-ROM, a DVD, or the like. The ROM 1309 stores a program to be executed by the CPU 1306.

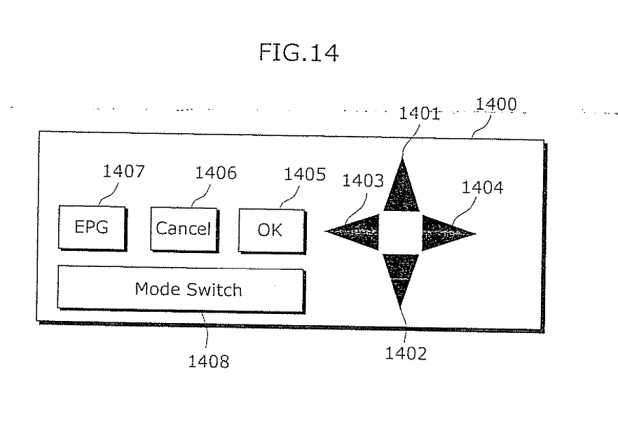

The input unit 1310 is, to be more specific, configured of a front panel and a remote control receiver, and accepts an input from the user. FIG. 14 shows an example of the input unit 1310 in the case where it is configured in the form of a front panel. A front panel 1400 has seven buttons: an up cursor button 1401, a down cursor button 1402, a left cursor button 1403, a right cursor button 1404, an OK button 1405, a cancel button 1406, an EPG button 1407, and a mode switch button 1408. When the user presses down a button, the identifier of such pressed button is notified to the CPU 1306.

The adapter 1311 is a device for descrambling a scrambled MPEG-2 transport stream sent in the In-band frequency range, and includes one or more descramblers. The MPEG-2 transport stream outputted by the tuner 1301a is inputted into the adapter 1311, which descrambles TS packets that have the PID specified by the CPU 1306. The adapter 1311 outputs the descrambled MPEG-2 transport stream to the TS decoder 1302.

Furthermore, the adapter 1311 also carries out format conversion of data sent in an OOB frequency range. Information transmitted through OOB is modulated using a QPSK modulation technique. Regarding outbound transmission, the QPSK demodulator 1301b demodulates the outbound signal sent from the broadcast station side system 101, and inputs a generated bit stream into the adapter 1311. The adapter 1311 extracts information specified by the CPU 1306 from among various information included in the bit stream, converts the information into a format that can be interpreted by a program that operates in the CPU 1306, and provides the resultant to the CPU 1306. On the other hand, regarding inbound transmission, the CPU 1306 inputs information to be sent to the broadcast station side system 401 into the adapter 1311. The adapter 1311 converts the information inputted from the CPU 1306 into a format that can be interpreted by the broadcast station side system 101, and sends the resultant to the QPSK modulator 1301c. The QPSK modulator 1301c QPSK-modulates the information inputted from the adapter 1311, and sends the resultant to the broadcast station side system 101.

A CableCARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The AV encoder 1312 outputs the encoded video and audio to the multiplexer 1313.

The multiplexer 1313 is a device that has a function to multiplex the video and the audio, which have been inputted from the AV encoder 1312, into an MPEG-2 transport stream.

An operation performed by the broadcast recording and reproduction apparatus described above to record a service contained in a broadcast wave into the secondary storage unit 1307, and an operation performed by the broadcast recording and reproduction apparatus to sequentially read out and reproduce the service from the secondary storage unit 1307, is hereafter described in detail.

First, the operation of recording the service contained in the broadcast wave into the secondary storage unit 1307 is described.

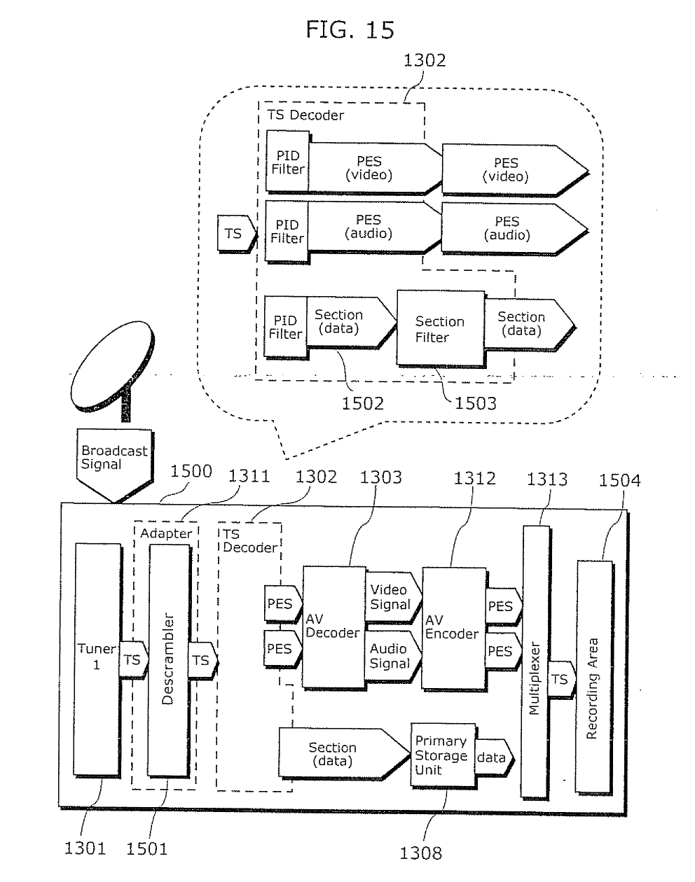

FIG. 15 shows a conceptual rendering which represents the physical connection sequence, processing details, and input/output data format of each device at the time of service recording. 1500 is a terminal apparatus, which has: the tuner 1301; the adapter 1311; a descrambler 1501; the TS decoder 1302; a PID filter 1502; a section filter 1503; the AV decoder 1303; the primary storage unit 1308; the AV encoder 1312; the multiplexer 1313; and a recording area 1504. Constituent elements in FIG. 15 that have the same reference numbers as in FIG. 13 have the same functions and thus their descriptions are not repeated.

First, the tuner 1301 performs tuning on the broadcast wave in accordance with a tuning instruction provided by the CPU 1306. The tuner 1301 demodulates the broadcast wave and inputs the MPEG-2 transport stream into the adapter 1311.

The descrambler 1501, which is within the adapter 1311, descrambles the MPEG-2 transport stream based on conditional access information for each viewer. The descrambled MPEG-2 transport stream is inputted into the TS decoder.

Two types of devices that process the MPEG-2 transport stream are present within the TS decoder 1302: the PID filter 1502 and the section filter 1503.

The PID filter 1502 extracts, from the inputted MPEG-2 transport stream, TS packets that have a PID specified by the CPU 1306, and then extracts a PES packet or an MPEG-2 section present in their payloads. For example, when the MPEG-2 transport stream in FIG. 6 is inputted in the case where the CPU 1306 has instructed PID filtering which extracts TS packets with a PID=100, packets 601 and 603 are extracted, then concatenated, and a PES packet of video 1 is reconfigured. Or, when the MPEG-2 transport stream in FIG. 6 is inputted in the case where the CPU 1306 has instructed PID filtering which extracts TS packets with a PID=200, packets 602 and 605 are extracted, then concatenated, and an MPEG-2 section of data 1 is reconfigured.

The section filter 1503 extracts an MPEG-2 section which conforms to a section filter condition specified by the CPU 1306 from among the inputted MPEG-2 sections, and DMA-transfers this MPEG-2 section to the primary storage unit 1308. For example, suppose that the CPU 1306 specifies, to the section filter 1503, PID filtering which extracts TS packets with a PID=200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the primary storage unit 1308.

The MPEG-2 section that is inputted into the primary storage unit 1308 is inputted into the multiplexer 1313.

The video PES packet and the audio PES packet extracted by the TS decoder 1302 are inputted into the AV decoder 1303.

The AV decoder decodes the video PES packet into the video, and inputs this into the AV encoder 1312. The AV decoder also decodes the audio PES packet into the audio, and inputs this into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted from the AV encoder onto the MPEG-2 section inputted from the primary storage unit 1308, and thus generates an MPEG-2 transport stream. The generated MPEG-2 transport stream is recorded into the recording area 1504.

The recording area 1504 is made up of all or a part of the secondary storage unit 1307, or another recording area, and records the MPEG-2 transport stream that makes up a service.

Next, an operation is described in which the service is sequentially read out from the secondary storage unit 1307 and reproduced.

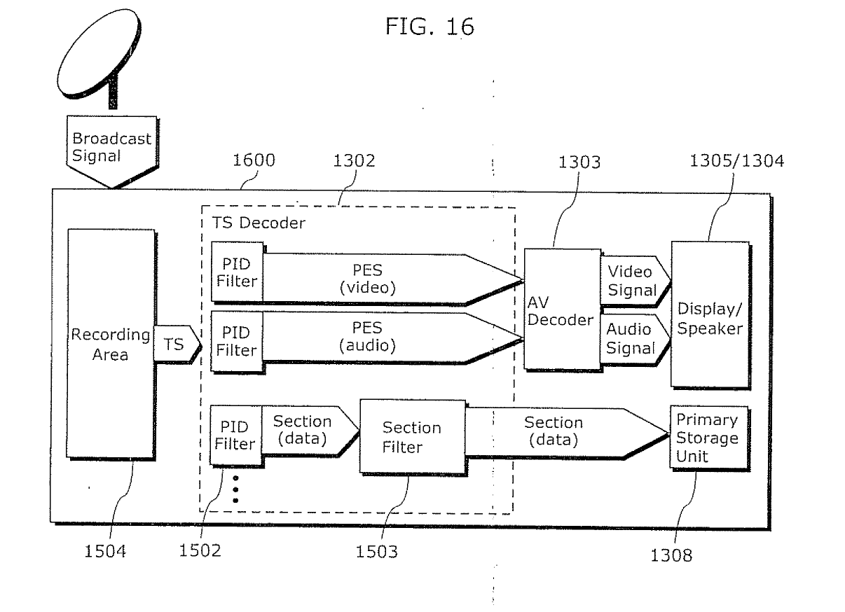

FIG. 16 shows a conceptual rendering which represents the physical connection sequence, processing details, and input/output data format of each device at the time of service reproduction. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 16 that have the same reference numbers as in FIG. 13 have the same functions and thus their descriptions are not repeated.

In the order described in FIG. 15, the MPEG-2 transport stream recorded in the recording area 1504 is inputted into the TS decoder 1302.

Then, a video PES and an audio PES that have a PID specified by the CPU 1306 are extracted by the PID filter 1502 within the TS decoder 1302. The extracted PES packets are inputted into the AV decoder 1303. Or, an MPEG-2 section that has a PID and a table_id specified by the CPU 1306 is extracted by the PID filter 1502 and the section filter 1503 within the TS decoder 1302. The extracted MPEG-2 section is DMA-transferred to the primary storage unit 1308. The video PES and the audio PES inputted into the AV decoder 1303 are decoded and outputted as an audio signal and a video signal. After that, the audio signal and the video signal are inputted into the display 1305 and the speaker 1304, thus reproducing the video and the audio.

The MPEG-2 section that is inputted into the primary storage unit 1308 is inputted into the CPU 1306 where appropriate.

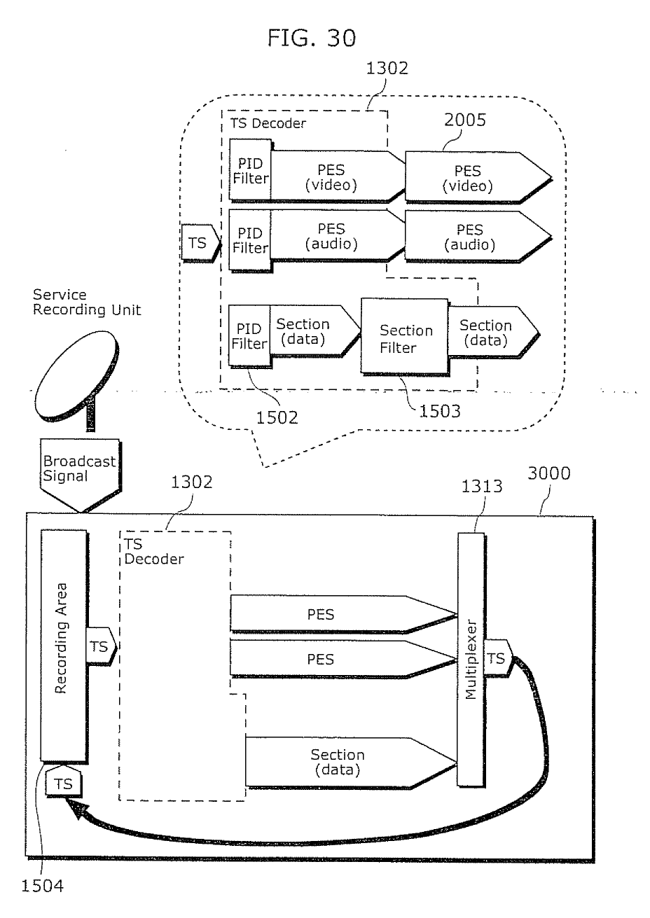

In the present embodiment, it is possible to record again into the secondary storage unit 1307 a service which is obtained by removing, from a service already recorded in the recording area, TS packets which carry a DSMCC section storing a Java program that should be deleted and then by multiplexing the resulting service. FIG. 30 shows a conceptual rendering which represents the physical connection sequence, processing details, and input/output data format of each device in such a case.

3000 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 30 that have the same reference numbers as in FIG. 13 have the same functions and thus their descriptions are not repeated.

In the order described in FIG. 15, the MPEG-2 transport stream recorded in the recording area 1504 is inputted into the TS decoder 1302.

Next, PIDs and Table_ids that remain after removing the PID and Table_id of the DSMCC section storing the Java program that should be deleted from among all the PIDs and Table_ids of the service already recorded in the secondary storage unit, are set to the PID filter of the TS decoder. Through this setting, the video PES and audio PES as well as DSMCC sections and AIT sections which are not subjected to deletion, are extracted. Then, the extracted PES packets are directly inputted to the multiplexer 1313.

The multiplexer 1313 multiplexes the MPEG video and MPEG audio outputted from the TS decoder with the MPEG-2 section so as to generate an MPEG-2 transport stream. The generated MPEG-2 transport stream is recorded into the recording area 1504.

The recording area 1504 is made up of all or a part of the secondary storage unit 1307, or another recording area, and records the MPEG-2 transport stream that makes up a service. Thus far, an example of a hardware configuration regarding the present invention has been described. Hereafter, a chief function of the present invention, which is control of recording of the service and control of trick play via a Java program, is described.

Recording of the service in the present invention refers to recording video, audio, a Java program, synchronization information of the Java program, and so on that are contained in the service, into an arbitrary recording medium such as a hard disk, a Blu-ray Disc (BD), a Digital Versatile Disc (DVD), and a Secures Digital (SD) memory card. Reproduction of the service refers to reproduction and execution of the video, audio, and Java program recorded in the recording medium, based on the synchronization information. A reproduction result of a recorded service is required to be almost equivalent to a result of directly reproducing the service upon receiving a broadcast wave.

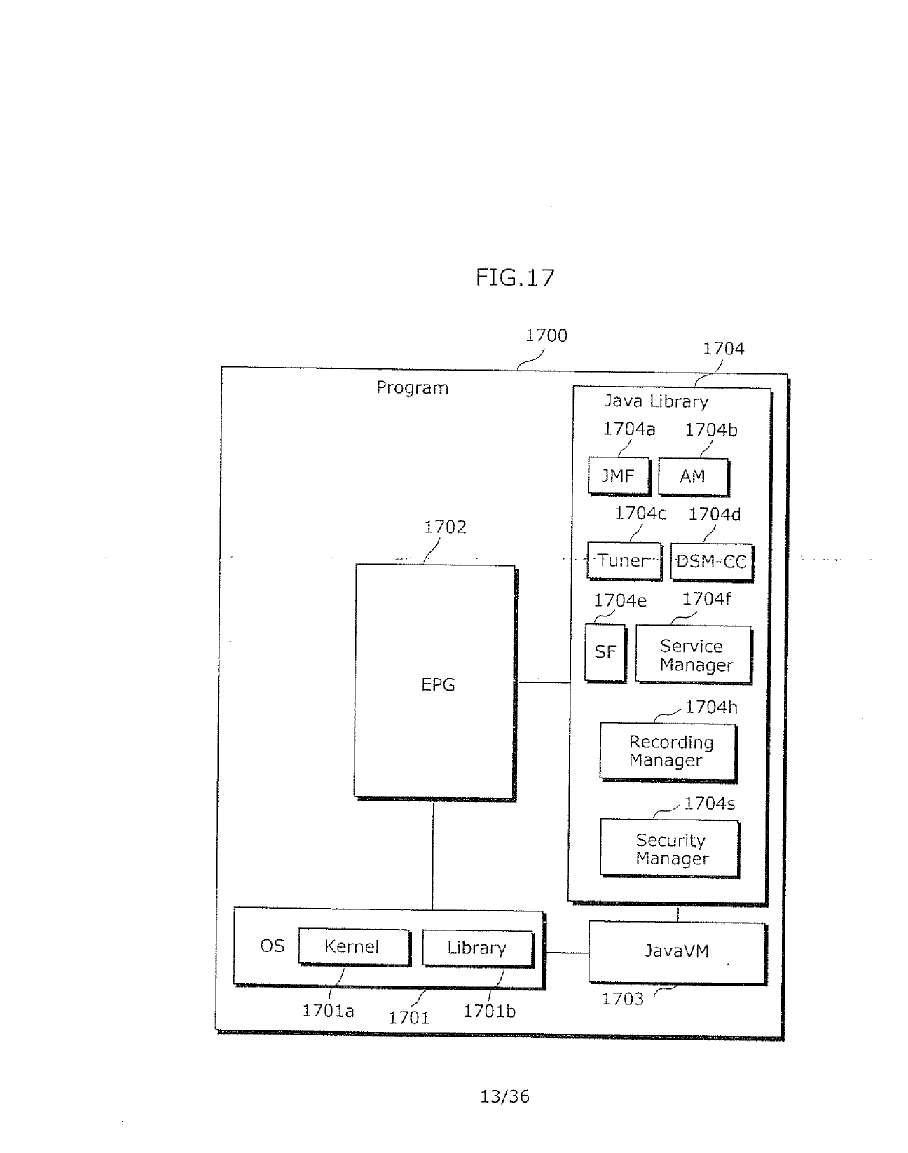

FIG. 17 is a diagram showing a structure of a program necessary for recording and reproduction of the service, the program being software recorded in the RON 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is made up of: a kernel 1701a for executing other sub-programs such as the EPG 1702 and the Java VM 1703; and a library 1701b which the sub-programs use to control the constituent elements of the terminal apparatus 1300. The kernel 1701a is publicly-known technology and therefore their detailed descriptions are not repeated.

The library 1701b provides, for example, a tuning function for controlling the tuner. The library 1701b accepts, from another sub-program, tuning information that includes a frequency, and passes this to the tuner 1301. The tuner 1301 is capable of performing demodulation based on the provided tuning information, and passing the demodulated MPEG-2 transport stream to the TS decoder 1302. As a result, other sub-programs can control the tuner 1301 through the library 1701b.

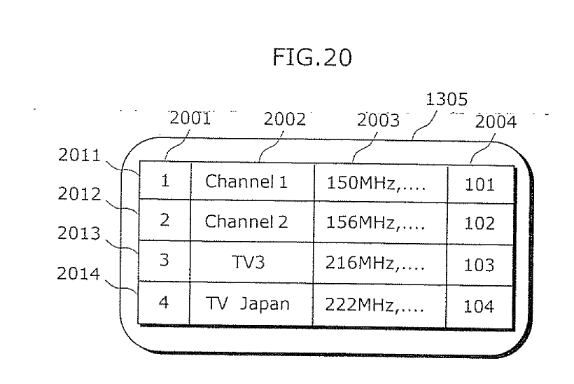

Also, the library 1701b provides channel information for uniquely identifying a channel. An example of the channel information is shown in FIG. 20. The channel information is sent using an OOB or an In-band frequency range, is converted into a chart format by the adapter 1311, and is stored into a temporary memory unit accessible by the library. A column 2001 describes channel identifiers, which are equivalent to, for example, a source_ID as defined by SCTE 65 Service Information Delivered Out-Of-Band For Digital Cable Television. A column 2002 describes channel names, which are equivalent to a source_name, from the same SCTE 65 standard. A column 2003 describes tuning information, which is information such as a frequency, a transfer rate, a modulation technique, and the like that is given to the tuner 1301. A column 2004 describes program numbers for specifying the respective PMTs. For example, a row 2011 describes a set of service information including a channel identifier of “1”, a channel name of “channel 1”, a frequency of “150 MHz . . . ” as the tuning information, and a program number of “101”.

In addition to this, it is also possible for the library 1701b to set parameters used in control of the hardware constituent elements shown in FIG. 13. Their individual functions are described later.

The Java VM 1703 is a Java virtual machine that sequentially analyzes and executes programs written in the Java™ language. Programs written in the Java language are compiled of intermediate code which does not depend on the hardware, called bytecode. The Java virtual machine is an interpreter which executes this bytecode. The Java VM 1703 executes the Java library 1704 that is written in the Java language. Details of the Java language and the Java VM are explained in publications such as “Java Language Specification” (ISBN 0-201-63451-1) and “Java Virtual Machine Specification” (ISBN 0-201-63451-X). In addition, it is possible to call or be called by other sub-programs not written in the Java language through a Java Native Interface (JNI). Details regarding the JNI can be found in the book “Java Native Interface” and so on.

The Java library 1704 is a library written in the Java language and which is called by a Java program in order to control functions of the broadcast recording and reproduction apparatus. However, there are situations where a sub-program not written in the Java language, such as the library 1701b of the OS 1701, is used as necessary. The Java program can use a function provided by the lava library 1740 by calling a Java Application Programming Interface (API) held by the Java library 1704.

A Tuner 1704c is a Java library for controlling the In-band receiving tuner 1301a in the broadcast recording and reproduction apparatus. When the Java program passes tuning information including a frequency to the Tuner 1704c, the Tuner 1704c uses that information to call a tuning function of the library 1701b, and as a result, it is possible to control an operation of the In-band receiving tuner 1301a of the broadcast recording and reproduction apparatus.

An SF 1704e is a Java library for controlling a function of the PID filter 1502 and the section filter 1503 of the broadcast recording and reproduction apparatus. When the Java program passes filter conditions such as a PID, table_id, and the like to the SF 1704e, the SF 1704e uses a function of the library 1701b and the like based on those conditions, so as to control the PID filter 1502 and the section filter 1503, acquires an MPEG-2 section that fulfills the desired filter conditions, and passes the MPEG-2 section to the Java program that set the filter conditions.

A DSM-CC 1704d is a lava library for accessing a file system of a DSM-CC object carousel. The DSM-CC object carousel is included in the MPEG-2 section acquired by the SF 1704e. The DSM-CC is defined by the ISO/IEC 13818-6 standard, and is a mechanism for using the MPEG-2 section to send an arbitrary file. By using this, it is possible to send a file from a broadcast station to a terminal. Based on a file identifier and the like specified by the Java program and so on, the DSM-CC 1704d uses the SF 1704e and acquires the MPEG-2 section, fetches a file based on the ISO/IEC 13818-6 standard, and outputs this file to the primary storage unit 1308, the secondary storage unit 1307, and the like. A detailed method for implementing the DSM-CC is of no relation to the present invention, and therefore its descriptions are not repeated.

An AM 1704b is an Application Manager that provides a function for managing the execution and termination of the Java programs contained in the service. The AM 1704b extracts a Java program multiplexed onto a specified channel in a specified MPEG-2 transport stream, and causes the execution or termination of that extracted Java program in accordance with separately-multiplexed synchronization information. A Java class file of the Java program is multiplexed onto the MPEG-2 transport stream in the aforementioned DSM-CC format. In addition, the synchronization information of the Java program is multiplexed onto the MPEG-2 transport stream in a format called AIT. AIT is an acronym of Application Information Table, as defined in section 10 of the DVB-MHP specification (ETSI TS 101 812 DVB-MHP specification V1.0.2), and is an MPEG-2 section with a table_id of “0x74”. In the descriptions of the present embodiment, the AIT used is a modified version of that which is defined by the DVB-MHP specifications.

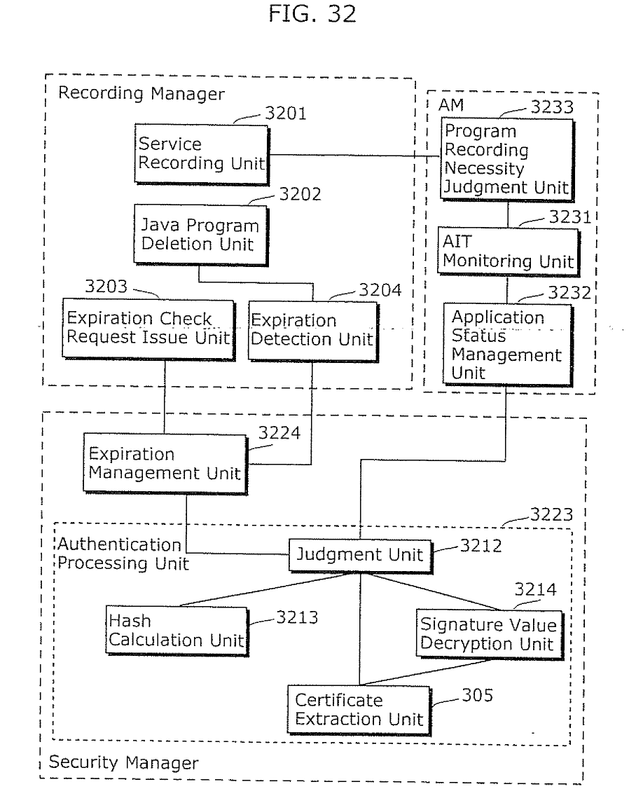

An internal configuration of the AM 1704b is shown in FIG. 32. The AM 1704b is configured of an AIT monitoring unit 3231, an application status management unit 3232, and a program recording necessity judgment unit 3233.

The AIT monitoring unit 3231 monitors a renewal state of the AIT, with the MPEG-2 transport stream and the channel identifier as inputs. First, the AM 1704a searches channel information in the library 1701b with a specified channel identifier as a key, and obtains the program number. Next, using the SF 1704e and the like, the PAT is acquired from the MPEG-2 transport stream. Then, the PID of the PMT that corresponds to the program number now obtained is obtained from the PMT information. Using the SF 1704e again, the actual PMT is acquired. The acquired PMT is in a format as shown in FIG. 11, where the PID of an elementary stream that has “data” as a stream type and “AIT” as supplemental information, is described. Furthermore, when the PID and table_id “0x74” of the AIT now obtained as the filter conditions are given to the SF 1704e, the actual AIT is obtained.

FIG. 22 is a chart that schematically shows an example of the AIT. An AIT version number 2200 expresses the version of that AIT. The higher the version of the AIT, the newer the AIT is. The AITs of the same AIT version are repeatedly received, but the AM 1704b does not analyze an AIT with the same AIT version as that of an already-analyzed AIT. The AM 1704b thus analyzes only an AIT that is newer than the already-analyzed AIT, and performs a corresponding process. A column 2201 describes the identifiers of the respective Java programs. According to the MHP specification, these identifiers are defined as Application IDs, which identify whether a Java program is a program that should be authenticated by a security manager 1704s of the terminal apparatus 1300. The security manager 1704s is described later. No authentication is required when the value of an identifier is in the range of 0x0 to 0x3fff, while authentication is required when the value of an identifier is in the range of 0x4000 to 0x7fff. A Java program whose identifier value falls within the former range is referred to as “unsigned program” and a Java program whose identifier value falls within the latter range is referred to as “signed program”.

A column 2202 describes control information of the respective Java programs. The control information includes “autostart”, “present”, “kill”, and the like; “autostart” means that the terminal apparatus 1300 executes the Java program automatically in an instant, “present” means not performing automatic execution, and “kill” means stopping the Java program. A column 2203 describes DSM-CC identifiers for extracting the PIDs of packets that include the respective Java programs in the DSM-CC format. A column 2204 describes the program names of the respective Java programs. Rows 2211, 2212, 2213, and 2214 are sets of information of the respective Java programs. The Java program defined in the row 2211 is a set of the Java program identifier “0x3221”, the control information “autostart”, the DSMCC identifier “1”, and the program name “a/TopXlet”.

Similarly, the Java program defined in the row 2212 is a set of the Java program identifier “0x3222”, the control information “present”, the DSMCC identifier “1”, and the program name “b/GameXlet”. Here, the three Java programs defined in the row 2211, row 2212, and row 2214 have the same DSMCC identifier. This indicates that these three Java programs are included in one file system encoded in the DSMCC format. Here, only four types of information are prescribed for each Java program, but in reality, more types of information are defined. Details can be found in the DVB-MHP specifications.

The application status management unit 3232 analyzes the details of the renewed AIT, and manages an execution status of the Java program based on the details of the AIT.

First, an operation of managing a Java program status is described hereafter. The application status management unit 3232 finds a Java program with control information of “autostart” from the AIT, and extracts the corresponding DSMCC identifier and Java program name. Referring to FIG. 22, the AM 1704b extracts the Java program in the row 2211 and acquires the DSMCC identifier of “1” and the Java program name of “a/TopXlet”. Next, the AM 1704b obtains, from the PMT, the ID of TS packets that store the Java program in the DSMCC format, using the DSMCC identifier obtained from the AIT. More specifically, the AM 1704b obtains, from the PMT, the ID of the elementary stream whose stream type is “Data” and whose DSMCC identifier in the additional information matches. Here, assuming that such DSMCC identifier is “1” and the PMT is the one shown in FIG. 11, the elementary stream in the row 1114 matches, and thus the PID “5014” is to be extracted.

The AM 1704b specifies, to the SF 1704e, a section filter condition as well as the PID of TS packets that carry an MPEG-2 section in which data is embedded in the DSMCC format. Here, the PID “5014” is provided. As a result, the AM 1704b can collect a necessary DSMCC MPEG-2 section. The AM 1704b reconstructs the file system from the collected MPEG-2 section in accordance with the DSMCC format, and stores the resultant into the primary storage unit 1308. Fetching data such as a file system from TS packets of the MPEG-2 transport stream and saving the data into a storage means such as the primary storage unit 1308 and the secondary storage unit 1307 is hereafter called downloading.

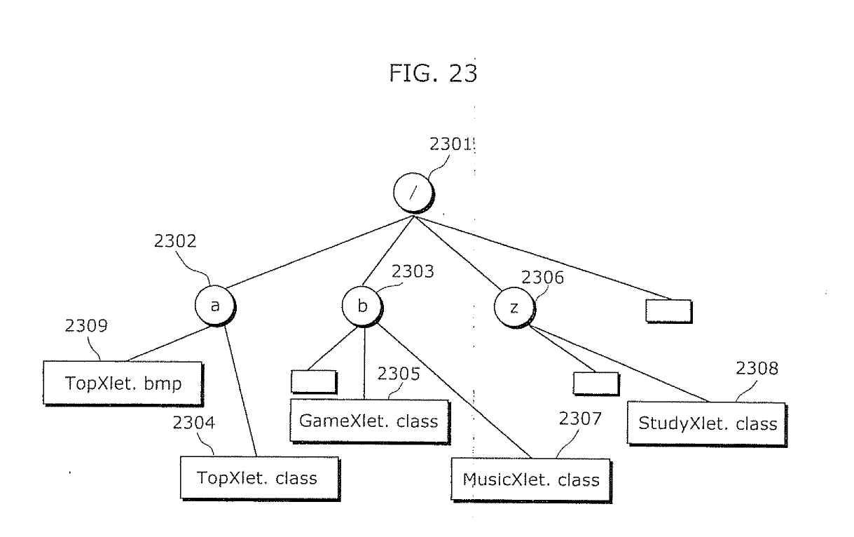

FIG. 23 is an example of a downloaded file system in the case where the identifier of a Java program to be executed indicates an unsigned program. In the diagram, a circle represents a directory and a square represents a file. 2301 is a root directory, 2302 is a directory “a”, 2303 is a directory “b”, 2304 is a file “TopXlet.class”, 2305 is a file “GameXlet.class” 2306 is a directory “z”, 2307 is a file “MusicXlet.class”, and 2308 is a file “StudyXlet.class”.

Next, the AM 1704b passes a Java program to be executed to the Java VM 1703, from the file system downloaded to the primary storage unit 1308. Here, when the name of the Java program to be executed is “a/TopXlet”, the file “a/TopXlet.class”, in which “.class” is added to the end of the Java program name, is the file to be executed. “/” is a directory and a file name delimiter, and referring to FIG. 23, the file 2304 is the Java program which should be executed. Next, when the AM 1704b passes the file 2304 to the Java VM 1703 without requesting the security manager 1704s to authenticate the Java program because of the reason that the row 2201 showing the identifier of such Java program indicates an unsigned program, such file is executed on the Java VM as a Java program.

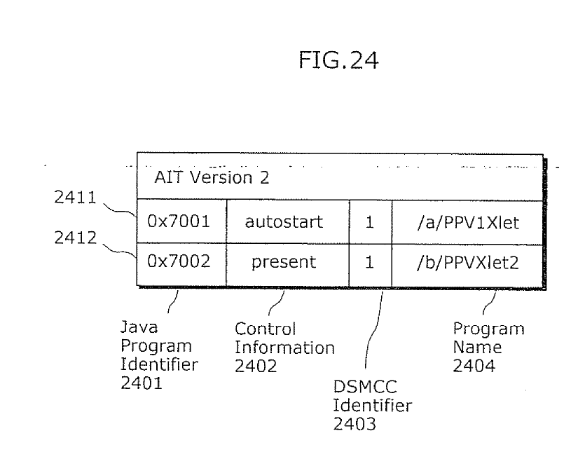

Meanwhile, FIG. 24 shows another example of the AIT in the case where the identifier of a Java program to be executed indicates a signed program. In the AIT shown in FIG. 24, the Java program defined in the column 2411 is a set of an identifier “0x7001”, control information “autostart” a DSMCC identifier “1”, and a program name “a/PPV1Xlet”. It is known from the Java program identifier Application ID that the Java program is a signed program.

Referring to FIG. 24, in the case where the identifier of a Java program to be executed indicates a signed program, the AM 1704b makes a request to authenticate the Java program by giving an authentication request notification to the judgment unit 3212 of the security manager 1704s. When notified by the security manager of the success of the authentication, the AM 1704b passes the file 2514 to the Java VM 1703, and such file is executed on the Java VM as a Java program. Meanwhile, when notified by the security manager of the failure of the authentication, the AM 1704b does not pass the file 2514 to the Java VM 1703.

The AM 1704b analyzes the AIT each time an AIT with a new AIT version is received and changes an execution status of a new Java program.

The program recording necessity judgment unit 3233 receives a service pre-recording notification from the service recording unit 3201 of the recording manager 1704h, and extracts an AIT multiplexed in a specified channel in an MPEG-2 transport stream specified using the AIT monitoring unit. Then, referring to FIG. 22, in the case where the column 2201 showing the identifier of the Java program described in the AIT indicates an unsigned program, a notification is made to the service recording unit 3201 indicating the necessity to record the Java program. Meanwhile, referring to FIG. 24, in the case where the Java program identifier of the Java program indicates a signed program, a File system that includes such Java program is downloaded, and the authentication of such Java program is requested by giving a pre-recording authentication request notification to the judgment unit 3212 of the security manager 1704s.

When notified by the security manager of the success of the authentication, the program recording necessity judgment unit 3233 notifies the service recording unit 3201 of the necessity to record the Java program. Meanwhile, when notified by the security manager of the failure of the authentication, the program recording necessity judgment unit 3233 notifies the service recording unit 3201 of the unnecessity to record the Java program.

The program recording necessity judgment unit 3233 analyzes the AIT each time an AIT with a new AIT version is received. In the case where a signed Java program is newly described, the program recording necessity judgment unit 3233 downloads such Java program, and makes a request to authenticate the Java program by giving a pre-recording authentication request notification to the judgment unit 3212 of the security manager 1704s.

When notified by the security manager of the success of the authentication, the AM 1704b notifies the service recording unit 3201 of the necessity to record the Java program. Meanwhile, when notified by the security manager of the failure of the authentication, the AM 1704b notifies the service recording unit 3201 of the unnecessity to record the Java program.

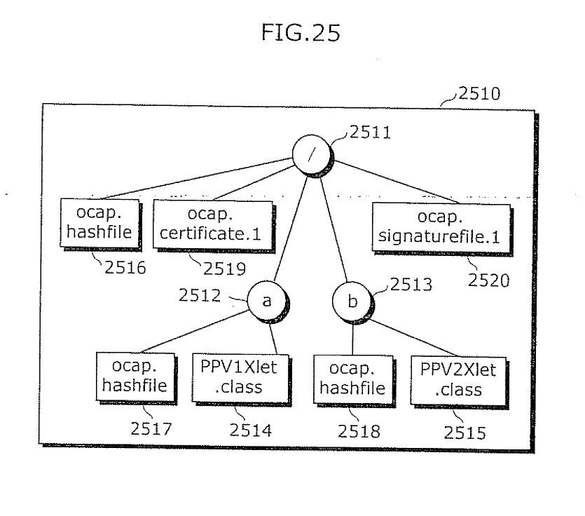

FIG. 25 shows an example of a file system that has been downloaded in association with the AIT shown in FIG. 24. Here, a file defined in the OCAP specification is described as an example. Elements in FIG. 25 which are the same as those in FIG. 24 are the same as each other, and therefore their descriptions are not repeated. 2510 is the downloaded file system, in which a top directory 2511, a directory “a” 2512, a directory “b” 2513, a file “PPV1Xlet.java” 2514, a file “PPV2Xlet.java” 2515, files “ocap.hashfile” 2516 to 2518, a file “ocap.hashfile.1,” 2519, and a file “ocap.signaturefile.1” 2520 are held.

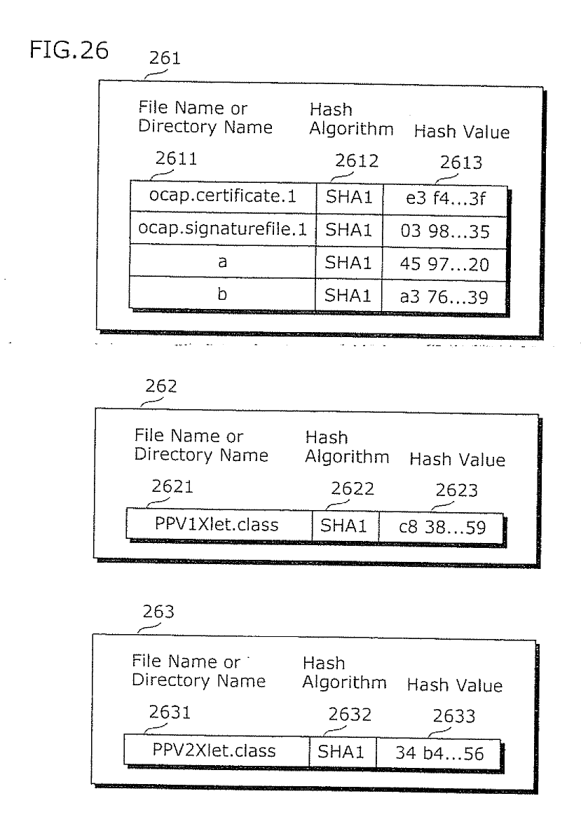

The files 2516 to 2518 are hash files, in which file names or directory names and their hash values are stored. In FIG. 26, 261, 262, and 263 are schematic diagrams respectively showing the details of “ocap.hashfile” 2516, “ocap.hashfile” 2517, and “ocap.hashfile” 2518. The “ocap.hashfile” of 261, which exists in the “/” directory 2511, includes, in a column 2611, an “ocap.certificate.1” file 2519, an “ocap.signaturefile.1” file 2520, an “a” directory 2512, and a “b” directory 2513 that exist in the same directory 2511.

A column 2212 indicates which hash algorithm was used to calculate each value described in a column 2613. The column 2613, which relates to the files or directories in the column 2611, includes hash values that were calculated by use of the algorithm specified in the column 2612. Currently, hash algorithms that are mainly used are Secure Hash Algorithm 1 (SHA1) and Message Digest 5 (MD5). These are publicly known algorithms for converting data with an arbitrary length into a fixed-length byte value, which have the following features: it is impossible to predict the original data after it is converted; and they are used to check if a file has been destroyed or tampered with. Meanwhile, a hash value is a pseudo random number that is generated by use of a hash algorithm. When a hash algorithm is SHA1, the length of a hash value is 20 bytes, whereas when a hash algorithm is MD5, the length of a hash value is converted into 16 bytes. For details about SHA1 and MD5, refer to “FIPS-PUB 186-2 Secure Hash Standard” and “IETF RFC1321”, respectively. Here, hash values that correspond to the respective directories “a” and “b” described in the column 2611 are SHA1 hash values that have been calculated respectively for the “ocap.hashfile” file 2517 existing in the “a” directory and the “ocap.hashfile” file 2518 existing in the “b” directory.

As in the case of “ocap.hashfile” in 261, included in “ocap.hashfile” in 262 are the file name, hash algorithm, and hash value of a “PPV1Xlet.class” file 2514 that exists in the same directory 2512. Similarly, included in 263 are the file name, hash algorithm, and hash value of a “PPV2Xlet.class” file 2515 that exists in the same directory 2513.

Here, only attributes that are related to the present invention are described, and thus the OCAP specification “OpenCable™ Application Platform Specification OCAP 1.0 Profile (OC-SP-OCAP1.0-IF-I09-031121)” should be referred to for details about “ocap.hashfile”.

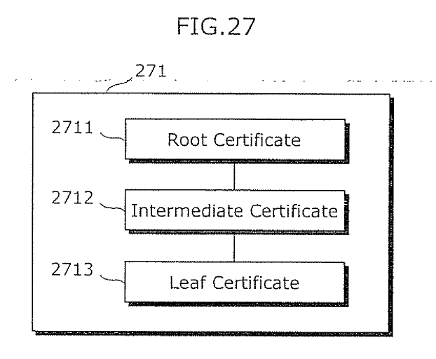

A file 2519 is a certificate chain. FIG. 27 is a block diagram showing a detailed structure of the “ocap.certificate.1”, file 2519. 271, which depicts a typical structure of “ocap.certificate.x” (x denotes a positive integer), contains a root certificate 2711, an intermediate certificate 2712, and a leaf certificate 2713. They are in a chain relationship in which the holder of the root certificate 2711 issues the intermediate certificate 2712 and the holder of the intermediate certificate 2712 issues the leaf certificate 2713, for example. Note that according to the OCAP specification, a certificate chain related to a signature file “ocap.signaturefile.x” is “ocap.certificate.x” having the same value “x”.

In the case of FIG. 25, a certificate chain that corresponds to the “ocap.signaturefile.1” is the “ocap.certificate.1”. Also, the root certificate 2711, the intermediate certificate 2712, and the leaf certificate 2713 are configured in the same X.509 certificate format. X.509 certificates are widely used in various fields in the information and communications industry as a de facto standard for certificate representation format, through the recommendation of the ITU-T. In FIG. 27, only three certificates are illustrated, but there are cases where more than one intermediate certificate exists. In this case, however, these intermediate certificates must be in a chained state in which they are related to each other.

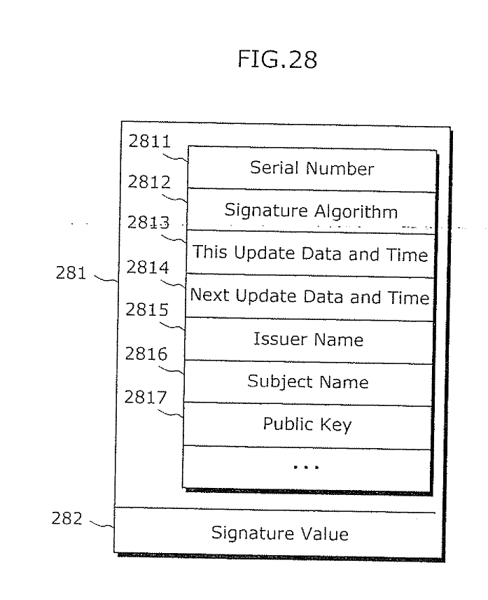

FIG. 28 is a diagram showing the structure of an X.509 certificate. Here, only the attributes that are required for describing the present invention are illustrated. For details about X.509 certificates, refer to IETF RFC3280 “Internet X.509 Public Key Infrastructure Certificate and CRL Profile”. 281 indicates an attribute area of the X.509 certificate and 282 indicates the signature value of the X.509 certificate. Serial number 2811 indicates the number to identify the certificate, signature algorithm 2812 indicates the algorithm used to calculate the signature value 282, this update date and time 2813 indicates the date and time when this X.509 certificate becomes valid, next update date and time 2814 indicates the date and time when this X.509 certificate expires, issuer name 2815 indicates the name of the authority that issued this X.509 certificate, subject name 2816 indicates the holder of this X.509 certificate, public key 2817 indicates the public key of the subject name 2816, and signature value 282 indicates a value that has been signed (encrypted) with the private key of the issuer of this X.509 certificate.

As a system utilizing public key and private key, public key cryptosystems are widely used for electronic commerce and others purposes. In a public key cryptosystem, an encrypted text is decrypted with a key that is different from the key used to encrypt the plaintext. Since the key for encryption and the key for decryption are different, it is impossible to estimate the key for encryption from the key for decryption even if the key for decryption is released to the public. This key for encryption corresponds to the private key and this key for decryption corresponds to the public key. Representative examples of public key cryptosystems include Rivest-Shamir-Adleman (RSA) and Digital Signature Standard (DSA).

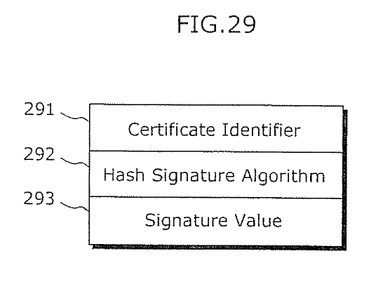

The file 2520 is a signature file. FIG. 29 is a schematic diagram showing the “ocap.signaturefile.1” file 2520. 291 indicates a certificate identifier for identifying which X.509 certificate is related, 292 indicates a hash signature algorithm, and 293 indicates a signature value that has been calculated from the “ocap.hashfile” 2516 by use of the hash signature algorithm indicated in 292.

FIG. 32 shows constituent elements of the security manager 1704s for performing authentication of a file system.

When receiving, from the AM 1704b, an authentication request notification to authenticate “/a/PPV1Xlet” and “/b/PPVXlet2” shown in 2404 in FIG. 24, the security manager 1704s performs authentication of the file system lower than the “/” directory of the lava programs. To verify the file system, authentication is performed by use of the ocap.hashfiles (2516 to 2518), the ocap.certificate.1 (2519), and the ocap.signaturefile.1 (2520) illustrated in FIG. 25. Then, the security manager 1704s notifies the AM 1704b of the result of the authentication.

The security manager 1704s includes an authentication processing unit 3223 and an expiration management unit 3224.

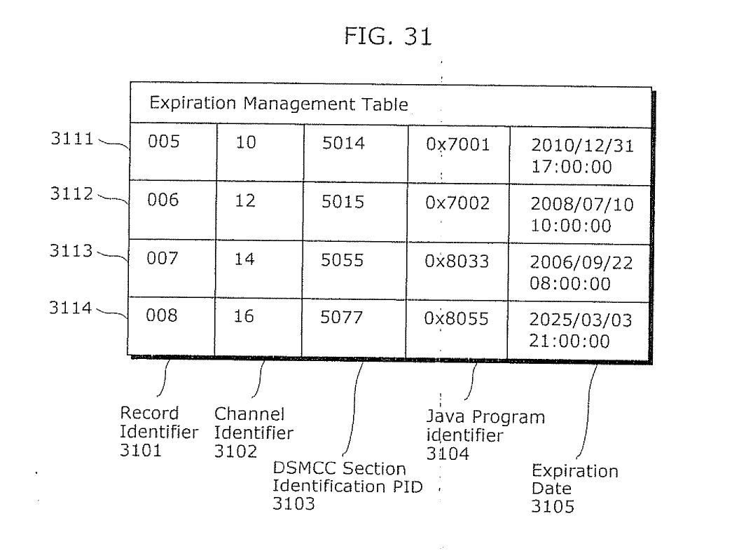

The expiration management unit 3224 holds the expiration dates of X.509 certificates of all Java programs specified by the AM 1704 in the case where such Java programs are signed programs. FIG. 31 is an example of the expiration management table for managing the expiration information recorded in the recording area 1504 of the secondary storage unit 1307 and the like. The expiration information is recorded in chart format. The expiration management table holds the expiration dates of X.509 certificates of all Java programs which are specified by the AM 1704 and which are signed programs. A column 3101 describes the record identifiers of the respective services including a Java program. A column 3102 describes the channel identifiers of the respective services including a Java program. A column 3104 describes the Java program identifiers of the respective Java programs. A column 3105 describes the expiration dates of X.509 certificates of the respective Java programs. A column 3103 describes DSMCC section identification PIDs indicating the PIDs of TS packets that carry DSMCC sections storing the respective Java programs.

Furthermore, when the recording manager 1704h issues an expiration check request to check the expiration of a Java program included in a service already recorded in the secondary storage unit 1307, the expiration management unit 3224 compares the current time with the expiration date of the X.509 certificate of such Java program. In the case where the current time has passed the expiration date of the X.509 certificate of such Java program, the expiration management unit 3224 notifies the recording manager 1704h of the Java identifier and the DSMCC section identification PID of the Java program as well as the fact that such Java program has expired.

The authentication processing unit 3223 further includes the following units 3212 to 3215.

The judgment unit 3212 receives, from the AM 1704b, an authentication request notification related to a specified Java program, and determines an authentication result. It requests a hash calculation unit 3213 to do hash calculations for the file system to receive hash values. The judgment unit 3212 extracts, from among the hash values 2613, 2623, and 2633 that exist in the “ocap.hashfile” file, a value to be compared and checks whether or not it matches the received hash values. If they do not match, the judgment unit 3212 judges that there has been tampering, and the authentication ends in failure.

Furthermore, the judgment unit 3212 extracts each of the X.509 certificates using a certificate extraction unit 3215, and judges if the current time is in between this update date and time 2813 and the next update date and time 2814 of each of the X.509 certificates. Note that current date and time is obtained from the library 1201b of the OS 1201. If there is no period validity satisfying “this update date and time<current date and time<next update date and time”, the judgment unit 3212 judges that the authentication is a failure.

Moreover, in order to authenticate the certificate chain, the judgment unit 3212 requests the hash calculation unit 3213 to do a hash calculation for the attribute area 281 of each of the X.509 certificates. Then, it requests a signature value decryption unit 3214 to do a calculation for decrypting the signature value 282 included in each of the X.509 certificates, and compares the resulting decrypted value with the hash values obtained by the hash value calculation unit 3213 so as to check the status of the certificate chain. If they do not match, it means that the certificates are not in a chain relationship, and thus the authentication is judged to be a failure. Meanwhile, when such values match and it has been verified that the certificates are in a chain relationship, it is checked whether the root certificate in the certificate chain is included in the secondary storage unit 1307 of the terminal apparatus 1300. If not included, the judgment unit 3212 judges that the authentication is a failure, with comparison being deemed impossible.

The judgment unit 3212 judges that authentication is successful when all of the following are satisfied: (1) there has been no tampering; (2) there is period validity; (3) certificates are in a chain relationship; and (4) root certificates match.

The judgment unit returns, to the AM 1704b, the authentication result determined by the judgment unit. When requested by the judgment unit 3212 to calculate a hash value of each of the files, the hash calculation unit 3213 extracts each of the files from the library 1701b of the OS 1701 to perform hash calculations for them, and passes the resulting values to the judgment unit 3212. Furthermore, the hash calculation unit 3213 obtains each of the X.509 certificates in the certificate chain 271 from the certificate extraction unit 3215, and performs hash calculations for the attribute area 281 of each of them.

The signature value decryption unit 3214 is requested by the judgment unit 3212 to perform a calculation for decrypting the signature value of either each X.509 certificate or “ocap.signaturefile.x”. When performing a calculation to decrypt the signature of each X.509 certificate, the signature value decryption unit 3214 obtains each of the X.509 certificates in the certificate chain 271 from the certificate extraction unit 3215, then performs a calculation for decrypting the signature of each of them, and returns the resultant to the judgment unit 3212.

In response to a request from the judgment unit 3212, the hash calculation unit 3213, and the signature value decryption unit 3214 to extract each of the X.509 certificates in the certificate chain 271, the certificate extraction unit 3215 extracts and returns the X.509 certificates.

A JMF 1704a handles control of reproduction of the video and audio contained in the service. More specifically, the JMF 1704a inputs, to the AV decoder, the video ES and the audio ES multiplexed in a specified channel in a specified MPEG-2 transport stream, and causes the AV decoder to reproduce them. In the case where a service is reproduced directly from a received broadcast wave, it is specified that an MPEG-2 transport stream outputted from the adapter 1311 be reproduced through the speaker 1304 and the display 1305. Meanwhile, in the case where a service is reproduced after being recorded on the secondary storage unit 1307 once, it is specified that an MPEG-2 transport stream outputted from the recording area 1504 inside the secondary storage unit 1307 be reproduced through the speaker 1304 and the display 1305.

First, the JMF 1704a searches channel information in the library 1701b with a specified channel identifier as a key, and obtains the program number. Next, using the SF 1704e and the like, the PAT is acquired from the MPEG-2 transport stream. Then, the PID of the PMT that corresponds to the program number now obtained is obtained from the PMT information. Using the SF 1704e again, the actual PMT is acquired. The acquired PMT is in a format as shown in FIG. 11, where the PIDs of elementary streams that have “video” and “audio” as their stream types, are described. When the JMF 1704a sets those PIDs in the PID filter 1502 of the TS decoder 1302 via the library 1701b, the video ES and the audio ES having those PIDs and are multiplexed, are reproduced via the AV decoder 1303, as well as the speaker 1304 and the display 1305 as shown in FIG. 15 or FIG. 16.

FIG. 32 shows a detailed internal configuration of the recording manager 1704h related to the present embodiment.

The recording manager 1704h includes a service recording unit 3201, a Java program deletion unit 3202, an expiration check request issue unit 3203, and an expiration detection unit 3204.

With the channel identifier, start time, and end time as inputs, the service recording unit 3201 of the recording manager 1704h records the service in the secondary storage unit 1307 only from the specified start time to end time. For example, when the channel identifier, start time, and end time are specified by the EPG 1702, the service recording unit 3201 waits until the start time. After that, when the start time is reached, the service recording unit 3201 starts recording the specified service, and ends the recording when the end time is reached. Hereafter, details of the operation of the service recording unit 3201 are described.

When the recording start time is reached, the service recording unit 3201 first secures, within the secondary storage unit 1307, a recording area 1504 for recording the MPEG-2 transport stream from the specified start time to the specified end time. A media identifier is supplied to the secured recording area. Next, with the channel identifier as a key, the service recording unit 3201 obtains tuning information that corresponds to the channel identifier from channel information held by the library 1701b. After that, when the service recording unit 3201 supplies the tuning information to the Tuner 1704c, the Tuner 1704c commences tuning. Here, the tuning information is information that can be specified, such as a frequency, a modulation method, and the like. Then, as shown in FIG. 15, the MPEG-2 transport stream is inputted into the TS decoder via the adapter 1311.

Meanwhile, using the SF 1704e, the service recording unit 3201 acquires the PAT from the MPEG-2 transport stream obtained through the tuning. In addition, the service recording unit 3201 searches the library 1701b for the program number that corresponds to the specified channel identifier, and searches the PAT for the PID of the PMT that corresponds to the obtained program number. Then, using the SF 1704e, the service recording unit 3201 obtains the actual PMT, and obtains all PIDs of audio, video, and section ESs that make up the service identified by the specified channel identifier The service recording unit 3201 of the recording manager 1704h sets the obtained PIDs to the PID filter 1502 of the TS decoder.

Next, the service recording unit 3201 of the recording manager provides the AM 1704b with the channel identifier, and makes a service pre-recording notification. When notified by the AM 1704b of the necessity to record all Java programs included in the service, as a result of the service pre-recording notification, the service recording unit 3201 of the recording manager sets, to the PID filter 1502 of the TS decoder, all PIDs of the audio, video, and section ESs that make up the service. After that, an output destination of each hardware constituent element is set through the library 1701b so as to follow the operations of recording the service included in the broadcast wave into the secondary storage unit 1307. Then, in accordance with the flow described in FIG. 15, all ESs that make up a desired channel are recorded into the recording area 1504 secured above.

On the other hand, when notified by the AM 1704b of the unnecessity to record one or more Java programs included in the service, the service recording unit 3201 of the recording manager sets, to the PID filter of the TS decoder, PIDs and Table_ids, which remain after removing, from among all the PIDs and Table_ids of the audio, video, and section ESs of the service, the PID of the DSMCC section storing the Java program(s) judged as unnecessary to be recorded as a result of the notification indicating the unnecessity to record the Java program(s). This is instructed through the library 1701b. In addition, an output destination of each hardware constituent element is set through the library 1701b, so as to flow through the path shown in FIG. 15. As a result, ESs are recorded into the recording area 1504, the ESSs remaining after removing TS packets that carry the DSMCC section storing the Java program(s) judged as unnecessary to be recorded, from among all ESs making up the desired channel.

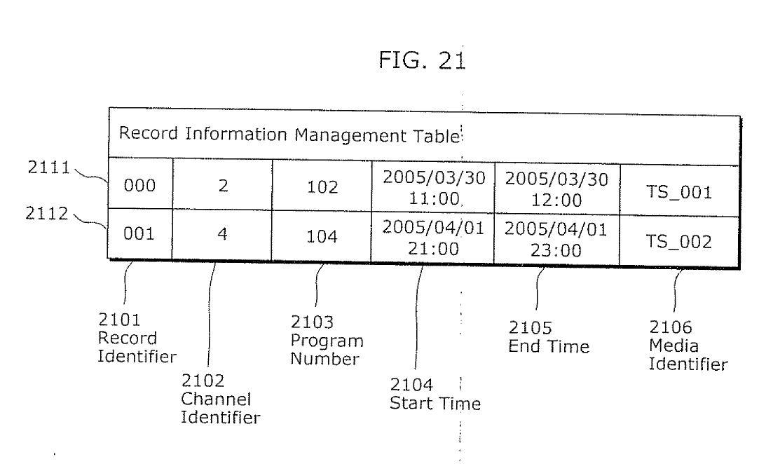

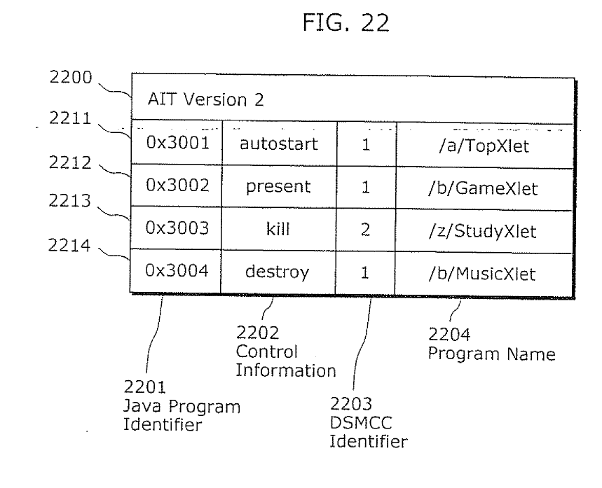

After that, when the specified end time is reached, the service recording unit 3201 stops the tuning operation of the Tuner 1704c, and causes the writing of the MPEG-2 transport stream to the recording area 1504 to end. In addition, a record information management table as shown in FIG. 21 is created as management information of the MPEG-2 transport stream recorded above.

FIG. 21 is an example of the record information management table for managing the record information recorded in the recording area 1504 of the secondary storage unit 1307 and the like. The record information is recorded in chart format. A column 2101 describes record identifiers. A column 2102 describes channel identifiers. A column 2103 describes program numbers. A column 2104 describes the record start times for the respective services, and a column 2105 describes the record end times for the respective services. A column 2106 describes media identifiers that identify each of MPEG-2 transport streams recorded as a service. Each of the rows 2111 and 2112 is a set of each record identifier, channel identifier, program number, start time, end time, and media identifier. For example, the row 2111 shows a record identifier of “000”, a channel identifier of “2”, a program number of “102”, a start time of “2005/03/30 11:00”, an end time of “2005/03/30 12:00”, and a media identifier of “TS_{—}001”.

Thus far, details of the operations of the service recording unit 3201 have been described.

When the expiration detection unit 3204 detects the expiration of a Java program included in a service recorded in a secondary recording area and requests to delete such expired Java program, the Java program deletion unit 3202 records, in replacement of the MPEG-2 transport stream already recorded in the secondary recording area, an MPEG-2 stream that is obtained by deleting the file system including the Java program from the MPEG-2 transport stream that includes the service and already recorded in the secondary storage unit 1307 and then by multiplexing again the resulting MPEG-2 transport stream.

When the expiration check request issue unit 3203 of the recording manager 1704h issues an expiration check request, the expiration management unit 3224 of the security manager 1704s checks the expiration dates of all Java programs included in the service in the already recorded MPEG transport stream. More specifically, the expiration management unit 3224 compares the current time with the expiration dates of all the Java programs held in the expiration management table. Then, in the case where the current time has passed the expiration date of any of the Java programs, the expiration management unit 3224 specifies the Java program identifier, record identifier, and section identification PID of such Java programs With reference to the expiration management table, and notifies the Java program deletion unit of the recording manager of the fact that the Java program has expired. The Java program deletion unit 3202 of the recording manager 1704h obtains the media identifier based on the record identifier specified by the Java program expiration notification, with reference to the record information management table.

Then, through the library 1701b, the service manager 1704f instructs the secondary storage unit 1307 to output, to the TS decoder 1302, the MPEG-2 transport stream identified by the media identifier now obtained. Next, PIDs and Table_ids that remain after removing the PID and Table_id of the DSMCC section storing the Java program to be deleted from among all the PIDs and Table_ids of the service already recorded in the secondary storage unit, is set to the PID filter of the TS decoder. This is instructed through the library 1701b. In addition, through the library 1701b, the service manager 1704f sets the output destination of each hardware constituent element to flow through the path shown in FIG. 30. Then, the TS decoder extracts TS packets with the specified PIDs and inputs them to the multiplexer, and the transport stream, from which the TS packets that carry the DSMCC section storing the expired Java program, is to be recorded into the recording area 1504, in replacement of the already recorded transport stream.

The expiration check request issue unit 3203 issues, to the expiration management unit 3224 of the security manager 1704s, an expiration check request to check the expiration of a Java program included in the service already recorded in the secondary storage unit 1307 by the service recording unit 3201.

More specifically, timing at which the expiration check request issue unit 3203 of the recording manager 1704h issues the expiration check request is as follows: at constant, periodic intervals which are set by the terminal apparatus 1700 in advance; record start time of a new service, or when copying or moving the service already recorded in a certain recording area in the secondary storage unit 1307 into another recording area; when there is a short of recording area; or the like. The expiration check request issue unit 3203 issues an expiration check request according to one of or a combination of these timings. Here, copying from a certain recording area to another recording area refers to dubbing of a service recorded in an HDD to a DVD, and the like. Note that it is possible to carry out the present invention regardless of timing at which the expiration check request issue unit 3203 issues an expiration check request, as long as the service is recorded in the secondary storage unit 1307.

The expiration detection unit 3204 detects a notification From the expiration management unit 3224 of the security manager 1704s indicating that a Java program has expired. When detecting the notification indicating that the Java program has expired, the expiration detection unit 3204 requests the Java program deletion unit to delete the expired Java program.

The service manager 1704f manages reproduction of a service in an MPEG-2 transport stream already recorded in the secondary storage unit 1307, or a service within an MPEG-2 transport stream inputted from the adapter 1311. Hereafter, an operation in the case of managing reproduction of a service contained within an MPEG-2 transport stream recorded in the secondary storage unit 1307 is described. This is equivalent to reproduction of an already recorded service. In this case, the service manager 1704f has the record identifier as an input. The To service already recorded in the secondary storage unit 1307 and identified by that record identifier is to be reproduced.

First, referring to the record information management table created by the recording manager 1704h, the service manager 1704f obtains the channel identifier and the media identifier of the service to be reproduced, based on the specified record identifier. Then, through the library 1701b, the service manager 1704f instructs the secondary storage unit 1307 to output, to the TS decoder 1302, the MPEG-2 transport stream identified by the media identifier now obtained. In addition, through the library 1701b, the service manager 1704f sets the output destination of each hardware constituent element to flow through the path shown in FIG. 16. After that, the secondary storage unit 1307 is provided to the JMF 1704a as the location of the MPEG-2 transport stream, and the channel identifier of the service to be reproduced is provided. Then, through the operation described above, the JMF 1704a starts reproduction of the video and audio multiplexed onto the MPEG-2 transport stream outputted from the secondary storage unit 1307.

Furthermore, the secondary storage unit 1307 is provided also to the AM 1704b as the location of the MPEG-2 transport stream, and the channel identifier of the service to be reproduced is provided. Then, in accordance with the AIT multiplexed onto the MPEG-2 transport stream outputted from the secondary storage unit 1307, the AM 1704b commences execution and termination of the Java program multiplexed onto the MPEG-2 transport stream outputted from the secondary storage unit 1307. After that, reproduction of the service is continued until the end of the MPEG-2 transport stream outputted from the secondary storage unit 1307.

Here, in the case where a Java program described in the AIT multiplexed in the MPEG-2 transport stream has not been recorded in the recording area due to the fact that its authentication failed at the time of service recording or where such Java program has been deleted from the recording area due to the fact that its validity turned out to be expired as a result of the expiration check request issue unit 2303 having issued an expiration check request by the time of reproduction, the same operation as the one performed when the authentication of the Java program fails at the time of service reproduction shall be performed.

More specifically, in the case where the download of the Java program from the recorded transport stream fails, the AM 1704b can address this by performing an operation on the assumption that it has received a notification from the judgment unit 3212 of the security manager 1704s indicating that the authentication has failed, as long as the AM 1704b finds out, with reference to the expiration management table shown in FIG. 31, that the Java program is described in the expiration management table and that the current time has passed the expiration date of the lava program.

On the other hand, the case of managing reproduction of the service within the MPEG-2 transport stream inputted from the adapter 1311 is described hereafter. This corresponds to reproducing the service directly from the broadcast wave. In this case, the service manager 1704f has the channel identifier of the service to be reproduced as an input.

Through the library 1701b, the service manager 1704f instructs that the MPEG-2 transport stream outputted from the adapter 1311 of FIG. 15 be outputted to the TS decoder 1302. In addition, through the library 1701b, the service manager 1704f sets the output destination of each hardware constituent element to flow through the path shown in FIG. 16. Furthermore, the adapter 1311 is provided to the JMF 1704a as the location of the MPEG-2 transport stream, and the channel identifier of the service to be reproduced is provided. Then, through the operation described above, the JMF 1704a starts reproduction of the video and audio multiplexed within the MPEG-2 transport stream outputted from the adapter 1311. Furthermore, the adapter 1311 is provided to the AM 1704b as the location of the MPEG-2 transport stream, and the channel identifier of the service to be reproduced is provided. Then, in accordance with the AIT multiplexed in the MPEG-2 transport stream outputted from the adapter 1311, the AM 1704b commences execution and termination of the Java program multiplexed in the MPEG-2 transport stream outputted from the secondary storage unit 1307.

After that, reproduction of the service is continued until the end of the MPEG-2 transport stream outputted from the secondary storage unit 1307.

The EPG 1702 is an acronym of Electric Program Guide, and is a function which lets a user choose a TV show to be recorded and reproduced. Normal reproduction after receiving a broadcast wave deviates from the scope of the present invention and thus its descriptions are not repeated.

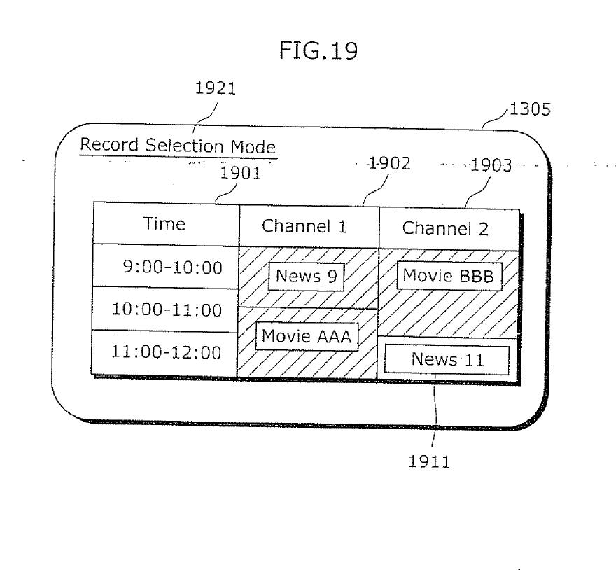

In the case of recording a TV show, the EPG 1702 displays a list of broadcast TV shows, and lets the user choose a desired TV show. FIG. 19 is an example of a screen display for letting the user select a TV show to be recorded. A time 1901 and channels 1902 and 1903 are displayed in a grid, and it is possible to check the TV so shows of each recordable channel at each time. It is possible for the user to move a focus 1911 within the screen by using top, bottom, right, and left cursor buttons 1401 to 1404, which are included in the input unit 1310 of the terminal apparatus 1300. Furthermore, when an OK button 1405 is pressed, the TV show which is currently highlighted is selected as a TV show to be recorded The EPG 1702 knows the channel identifier of the TV show since it has acquired it from the library, and when the TV show to be recorded is selected by the user, the EPG 1702 notifies the recording manager 1704h of the channel identifier, start time, and end time of the TV show. Based on that information, the recording manager 1704h records the TV show into the secondary storage unit 1307.

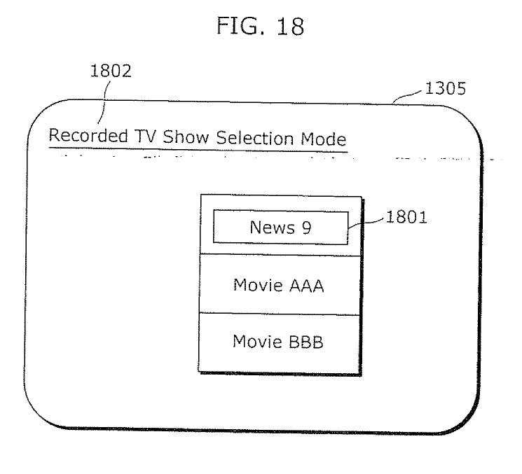

On the other hand, in the case of reproducing an already recorded TV show, the EPG 1702 displays a list of the already recorded TV shows, and lets the user choose a desired TV show. FIG. 18 is an example of a screen display for selecting an already recorded TV show. All TV shows stored in the secondary storage unit 1307 at that point in time are listed. It is possible for the user to move a focus 1801 within the screen by using the top and bottom cursor buttons 1401 and 1402, which are included in the input unit 1310 of the terminal apparatus 1300. Furthermore, when the OK button 1405 is pressed, the TV show which is currently highlighted is selected as a TV show to be reproduced. The EPG 1702 knows the record identifier of the TV show since it has acquired it from the recording manager 1704h, and when the TV show to be reproduced is selected by the user, the EPG 1702 notifies the service manager 1704f of the record identifier of that TV show. Based on that information, the service manager 1704f reads out and reproduces the TV show from the secondary storage unit 1307.

A characteristic operation of the broadcast recording and reproduction apparatus with the above-described structure is described hereafter.

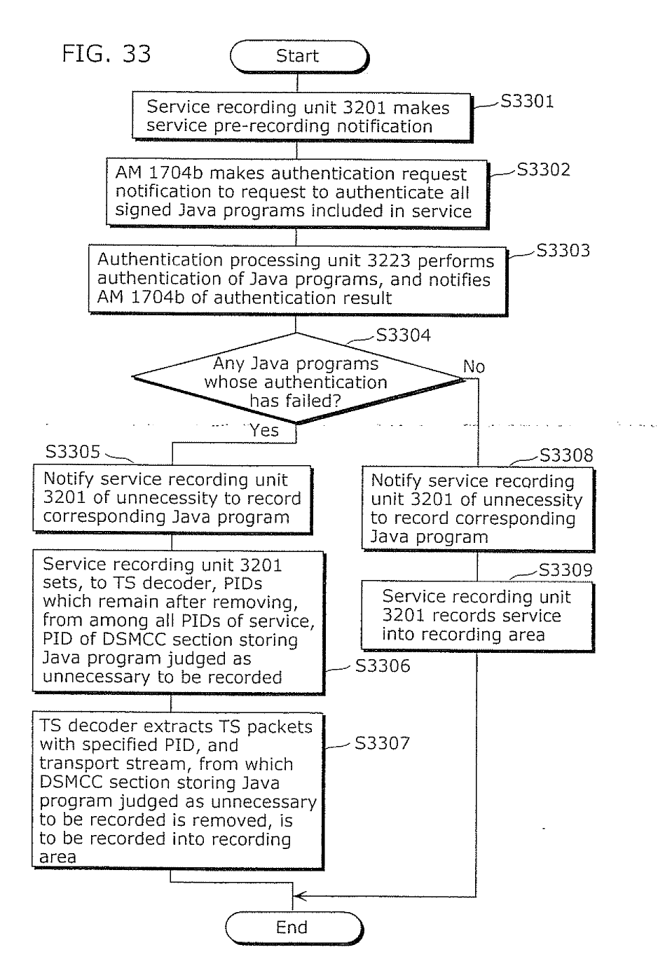

FIG. 33 is a flowchart showing an example of processes to be performed when the service recording unit 3201 of the present embodiment makes a service pre-recording notification.

The service recording unit 3201 of the recording manager 1704h makes a service pre-recording notification to the AM 1704b (S3301).

The AM 1704b makes an authentication request notification to the security manager 1704s to request to authenticate all signed Java programs included in the service (S3302).

The authentication processing unit 3223 of the security manager 1704s performs authentication of the file system lower than the “/” directory of the Java programs, and notifies the AM 1704b of the authentication result (S3303).

When the security manager 1704s notifies the failure of authenticating any of the Java programs (S3304), the AM 1704b notifies the service recording unit 3201 of the recording manager 1704h of the unnecessity to record the Java program (S3305).

When notified of the unnecessity to record the Java program, the service recording unit 3201 of the recording manager 1704h sets, to the PID filter of the TS decoder, PIDs and Table_ids which remain after removing, from among all the PIDs and Table_ids of the audio, video, and section ESs of the service, the PID of the DSMCC section storing the Java program judged as unnecessary to be recorded as a result of the notification indicating the unnecessity to record the Java program. This is instructed through the library 1701b. In addition, through the library 1701b, the output destination of each hardware constituent element is set to flow through the path shown in FIG. 15 (S3306). Then, the TS decoder inputs, to the multiplexer, the video, audio, and section ESs extracted by the PID filter based on the specified PIDs and Table_ids. As a result, ESs are recorded into the recording area 1504, which remain after removing TS packets that carry the DSMCC section storing the Java program judged as unnecessary to be recorded (S3307).

Meanwhile, in the case where the security manager 1704s notifies the success of authenticating the Java programs (S3304), the AM 1704b notifies the service recording unit of the recording manager 1704h of the necessity to record the Java program (S3305), and the service recording unit 3201 of the recording manager 1704h sets all the PIDs of the audio, video, and section ESs making up the service to the PID filter 1502 of the TS decoder, and records the whole service included in the broadcast wave into the secondary storage unit 1307 (S3309).

As described above, it is possible to record, into the secondary storage unit 1307, a service obtained by removing, from the service included in the broadcast wave, the file system that includes a Java program judged as unnecessary to be recorded and then by multiplexing the resultant.

Furthermore, when receiving an AIT with a new version at a point in time when time has elapsed from the start of service recording, the AM 1704b notifies the service recording unit of the necessity or unnecessity to record a new signed Java program described in the AIT, using the above-described method, and the service recording unit records, into the secondary storage unit 1307, a service obtained by removing the file system that includes the Java program judged as unnecessary to be recorded and then by multiplexing the resultant, using the above-described method.

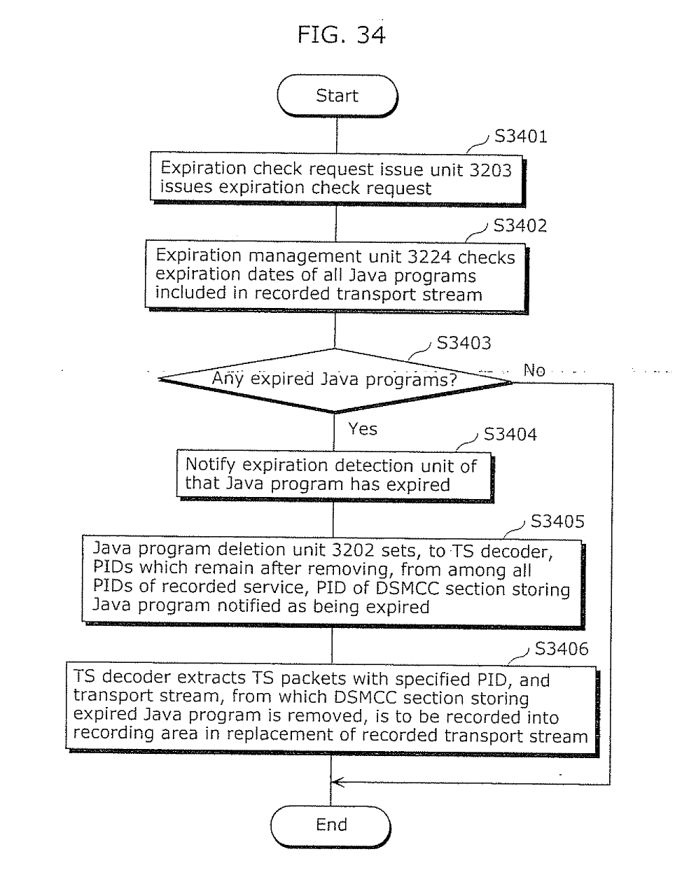

FIG. 34 is a flowchart showing an example of processes to be performed when the expiration check request issue unit 3203 in the present embodiment issues an expiration check request.

When the expiration check request issue unit 3203 of the recording manager 1704h issues an expiration check request (S3401), the expiration management unit 3224 of the security manager 1704s checks the expiration dates of all Java programs included in a service in an already recorded MPEG transport stream. More specifically, the expiration management unit 3224 compares the current time with the expiration dates of all the Java programs held in the expiration management table (S3402).

Then, in the case where the current time has passed the expiration date of any of the Java programs (S3403), the expiration management unit 3224 specifies the Java program identifier, record identifier, and section identification PID of the Java program, with reference to the expiration management table, and notifies the Java program deletion unit of the recording manager of the fact that the Java program has expired (S3404).

The Java program deletion unit 3202 of the recording manager 1704h obtains the media identifier based on the record identifier specified by the Java program expiration notification, with reference to the record information management table. Then, through the library 1701b, the service manager 1704f instructs the secondary storage unit 1307 to output, to the TS decoder 1302, the MPEG-2 transport stream identified by the media identifier now obtained.

Next, the PIDs and Table_ids that remain after removing the PID and Table_id of the DSMCC section storing the Java program to be deleted, from among all the PIDs and Table_ids of the service already recorded in the secondary storage unit, are set to the PID filter of the TS decoder. This is instructed through the library 1701b. In addition, through the library 1701b, the service manager 1704f sets the output destination of each hardware constituent element to flow through the path shown in FIG. 30 (S3405). Then, the TS decoder inputs TS packets with the specified PIDs to the multiplexer, and the transport stream, from which TS packets that carry the DSMCC section storing the expired Java program, is to be recorded into the recording area 1504 in replacement of the already recorded transport stream (S3406).

Meanwhile, in the case where the current time has passed the expiration date of none of the Java programs (S3403), the expiration management unit 3224 ends the processing without performing anything.

As described above, it is possible to record, into the secondary storage unit 1307, a service obtained by removing TS packets storing the expired Java program from the already recorded MPEG transport stream and then by multiplexing the resultant.

Note that it has been described in the present embodiment that, when notified by the security manager 1704s of the failure of authenticating a Java program, the AM 1704b notifies the service recording unit 3201 of the unnecessity to record the Java program, whereas when notified by the security manager 1704s of the success of authenticating a Java program, the AM 1704b notifies the service recording unit of the necessity to record the Java program. However, it is also possible to carry out the present invention in the following structure: the security manager 1704s does not notify the service recording unit of the necessity to record a lava program in the case of notifying the success of authenticating the Java program, and the service recording unit records the whole service included in the broadcast wave if it has not received any notifications indicating the necessity to record the Java program for a certain period of time.

As described above, according to the present embodiment, by not recording a Java program with an expired X.509 certificate into the secondary storage unit 1307 at the time of recording a service or by deleting, from a recording area, such Java program with an expired X.509 certificate included in a service already recorded in the recording area, it becomes possible to make an effective use of a recording area by reducing wasteful use of a recording area, which is caused by recording a Java program to be no longer activated. Furthermore, by regularly checking the expiration date of the certificate of a Java program, it becomes possible to reduce the waste of authenticating a Java program with an expired certificate at the time of activating the Java program, and thus to shorten the time required to activate the Java program.

### Second Embodiment

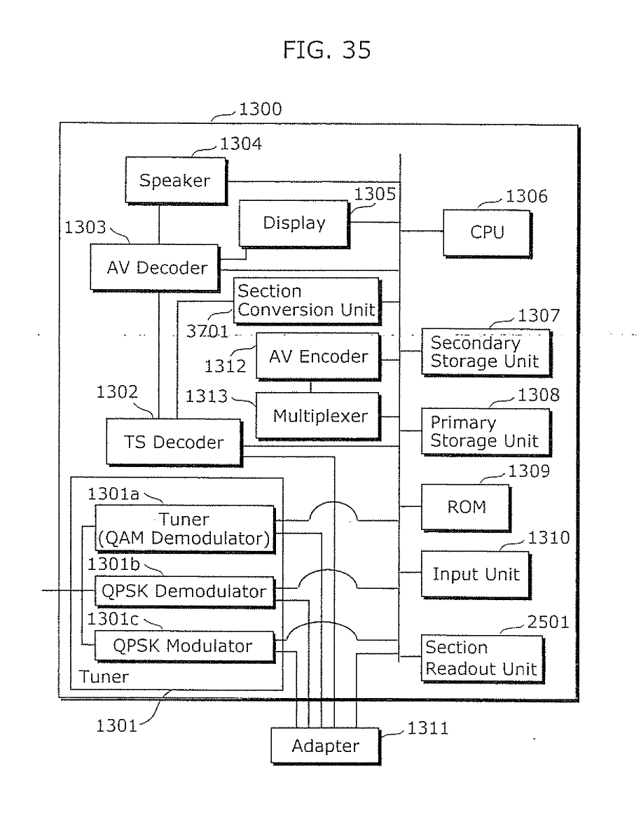

FIG. 35 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is a broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; a multiplexer (MPEG-2 Transport Stream Multiplexer or the like) 1313; a section conversion unit 3701; and a section readout unit 3801. Aside from the multiplexer 1313; the section conversion unit 3701, and the section readout unit 3801, elements that have the same names and reference numbers as those shown in FIG. 13 described in the first embodiment are identical to those described in the first embodiment, and therefore their descriptions are not repeated.

The multiplexer 1313 differs from that of the first embodiment in that it does not multiplex an AIT section and a DSMCC section. Aside from that, the multiplexer 1313 is the same. The section conversion unit 3701 records sections which have not been multiplexed by the multiplexer, into a recording area 1504 of the secondary storage unit 1307. After passing through the primary storage unit 1308, the AIT section and the DSMCC section that have been filtered by the TS decoder 1302 pass through the section conversion unit 3701 and are recorded into the recording area 1504 without going through the multiplexer. Here, a recording method when recording the sections into the recording area 1504 differs depending on section format.

In the case of a file system recorded within an MPEG-2 transport stream in a DSMCC file system Format, the section conversion unit 3701 converts this file system into a file system format unique to the recording area 1504, which is in turn unique to the a terminal, and records the resulting file system into the recording area 1504.

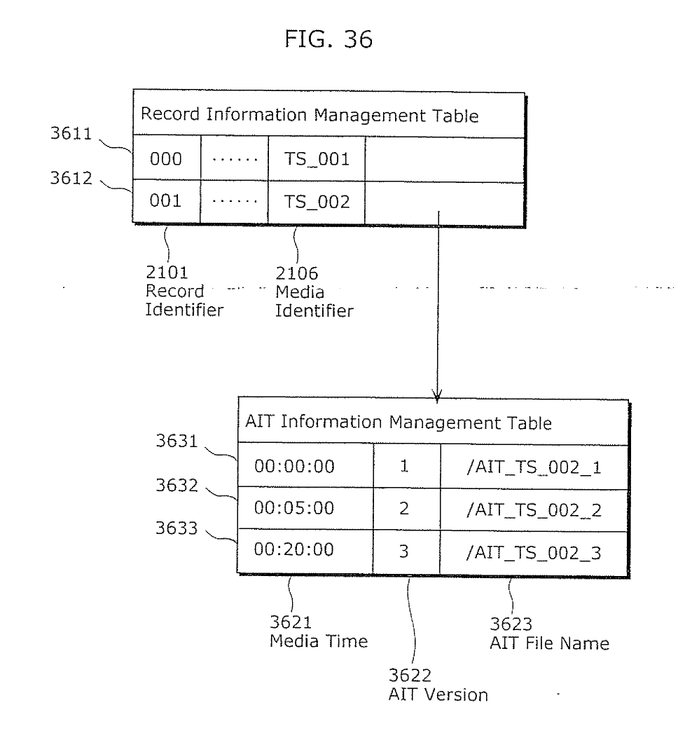

In addition, in the case of an AIT, the section conversion unit 3701 converts the AIT into an expanded record information management table format as shown in FIG. 36, and records the resulting AIT into the recording area 1504. The record information management table shown in FIG. 36 is an expanded version of the record information management table shown in FIG. 21, and as the items identified with the same reference numbers in both tables have the same meaning as those in the record information management table shown in FIG. 21, their descriptions are not repeated.

Each of the rows 3611 and 3612 shows record information for one service. Each of the rows 3611 and 3612 has a record identifier 2101, a channel identifier 2102, a program number 2103, a service record start time 2104, a service record end time 2105, a media identifier 2106, and a reference 3607 to an AIT information management table. The AIT information management table has a media time 3621 and an AIT version 3622 corresponding thereto. The media time 3621 is a time stamp in the corresponding MPEG-2 transport stream showing a position in the corresponding MPEG-2 transport stream. An AIT version 3622 corresponds to an AIT version 2200 in FIG. 22. For example, record information of the service that has a record identifier 2101 of “001” has a media identifier 2106 of “TS_{—}002”, and at the media time 3621 of “00:00:00” in the referred AIT information management table, the corresponding AIT version 3622 is “1”. In the same manner, the AIT version 3622 corresponding to the media time 3621 of “00:05:00” is “2”, and the AIT version 3622 corresponding to the media time 3621 of “00:20:00” is “3”.

For example, at the time of reproduction of the service that has a channel identifier 3601 of “001”, referring to the record information management table, the MPEG-2 transport stream that is multiplexed with the video and audio identified by the media identifier 3602 of “TS_{—}002” is reproduced; in addition, referring to the AIT information management table, when the media time 3621 reaches “00:00:00”, control which causes the lava program to start up or terminate is performed in accordance with the AIT with an AIT version 3622 of “1”. In a similar manner, the control which causes the Java program to start up or terminate is performed in accordance with the AIT with an AIT version 3622 of “2” when the media time 3621 reaches “00:05:00”, and in accordance with the AIT with an AIT version 3622 of “3” when the media time 3621 reaches “00:20:00”. The actual AIT is converted, as a binary file in private section format, into the file system format unique to the recording area 1504, which is in turn unique to a terminal, and is recorded into the recording area 1504. The recorded file is given a unique file name by which it can be uniquely identified, and which is recorded into the record information management table as an AIT file name 3623.

In an actual broadcast wave, AITs with the same AIT version are repeatedly transmitted for a number of times, but in the present embodiment, by detecting a change in the version of the received AIT, only the first AIT that is updated at that point in time is recorded into the recording area 1504.

The section readout unit 2901 searches the record information management table for the media time that corresponds to the present reproduction time of the MPEG-2 transport stream read out from the recording area, and reads out, from a file, the AIT and DSMCC file system corresponding to that media time, and passes these to a software AIT monitoring unit. In other words, the AIT monitoring unit 3231 does not refer to a filtering result of the TS decoder as in the first embodiment, but rather obtains an AIT binary file and a DSMCC file system from the section readout unit 2901.

An operation in which the broadcast recording and reproduction apparatus described above records a service contained in a broadcast wave into the secondary storage unit 1307, and an operation in which the broadcast recording and reproduction apparatus sequentially reads out and reproduces the service from the secondary storage unit 1307, are described hereafter in detail.

First, the operation in which the service contained in the broadcast wave is recorded into the secondary storage unit 1307 is described.

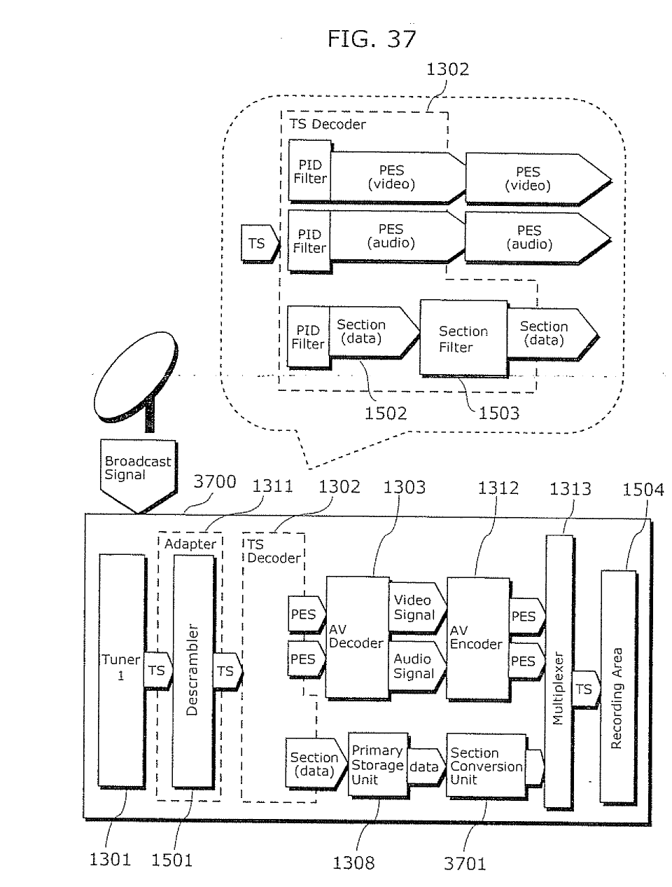

FIG. 37 shows a conceptual rendering which represents the physical connection sequence, processing details, and input/output data format of each device at the time of service recording. Constituent elements in the diagram that have identical numbers to the constituent elements shown in FIG. 15 have already been described in the first embodiment, and therefore their descriptions are not repeated. As opposed to FIG. 15, with the hardware configuration shown in FIG. 37, after passing through the primary storage unit 1308, the AIT section and the DSMCC section that have been filtered by the TS decoder 1302 pass through the section conversion unit 3701 and are recorded into the recording area 1504 without going through the multiplexer.

Next, description is given regarding an operation in which the recorded MPEG-2 transport stream is sequentially read out from the secondary storage unit 1307 and the service is reproduced.

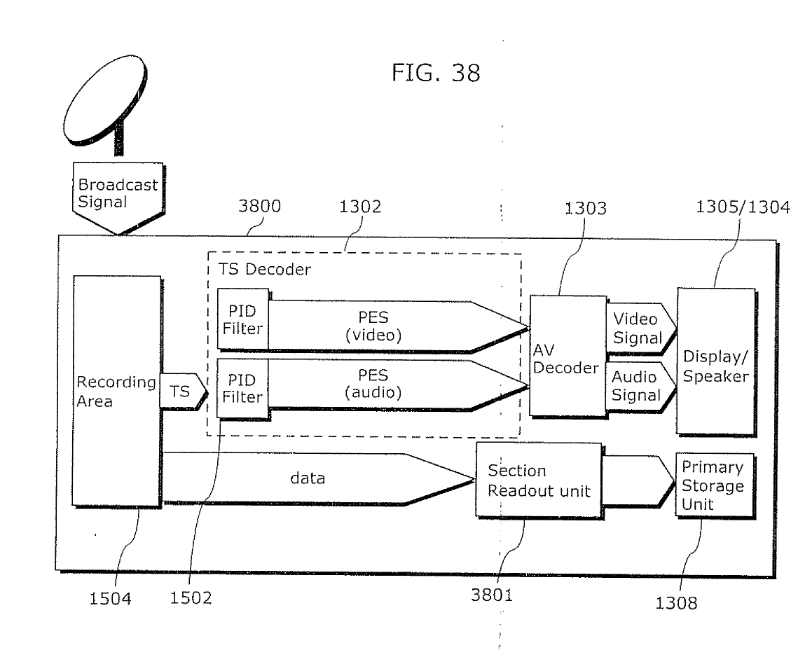

FIG. 38 shows a conceptual rendering which represents the physical connection sequence, processing details, and input/output data format of each device at the time of service reproduction. Constituent elements in the figure that have identical numbers to the constituent elements shown in FIG. 16 have already been described in the first embodiment, and therefore their descriptions are not repeated.

The hardware configuration of FIG. 38 differs from that in FIG. 16 in that the section recorded into the recording area 1504 is loaded into the primary storage through the section readout unit 2901 without going through the TS decoder.

Thus far, an example of a hardware configuration regarding the present invention has been described. Hereafter, a chief function of the present invention, which is control of recording of the service and control of trick play via a Java program, is described

The configuration of a program necessary for recording and reproduction of the service in the present invention is as shown in FIG. 17 and FIG. 32, the program being software recorded into the ROM 1309. Of the constituent elements shown in the figure, constituent elements other than the recording manager 1704h and the AM 1704b have the same functions as those in the first embodiment, and therefore their descriptions are not repeated. Furthermore, in the present embodiment, descriptions of constituent elements that perform the same operations as those in the first embodiment are not repeated.

The recording manager 1704h according to the present embodiment has a detailed internal configuration as that shown in FIG. 32 of the first embodiment.

In the present embodiment, when notified by the AM 1704b of the necessity to record all Java programs included in the service, the service recording unit 3201 of the recording manager 1704h sets an output destination of each hardware constituent element through the library 1701b so as to follow the operations of recording the service included in the broadcast wave into the secondary storage unit 1307. Accordingly, in accordance with the flow described in FIG. 35, all ESs as well as AIT and DSMCC files that make up a desired channel are recorded into the recording area 1504.

On the other hand, when notified by the AM 1704b of the unnecessity to record one or more Java programs included in the service, the service recording unit 3201 of the recording manager instructs the section conversion unit 3701 to convert the DSMCC file system into a file format unique to the recording area 1504, which is in turn unique to the a terminal, and then to record the resulting file system into the recording area 1504 when the section conversion unit 3701 converts a section which has not been multiplexed by the multiplexer and which has been filtered by the TS decoder 1302 into a unique file system format and then records the resulting section into the recording area 1504. Alternatively, the service recording unit 3201 instructs the section conversion unit 3701 to remove the Java program judged as unnecessary to be recorded from the DSMCC file system and then to record the resulting file system into the recording area 1504 after converting the DSMCC file system into a unique file system format. Accordingly, ESs that remain after removing the Java program judged as unnecessary to be recorded from all ESs making up a desired channel, as well as AIT and DSMCC files are recorded into the recording area 1504.

The other operations are the same as those of the service recording unit 3201 of the first embodiment.

In the present embodiment, when the expiration detection unit 3204 detects the expiration of a Java program included in a service recorded in a secondary recording area and requests to delete such expired Java program, the Java program deletion unit 3202 of the recording manager 1704h deletes the Java program from the DSMCC file system already recorded in the secondary recording area after being converted into a file system format unique to the recording area 1504, which is in turn unique to the a terminal. The other operations are the same as those of the Java program deletion unit 3202 of the first embodiment.

In the present embodiment, the AM 1704b has an internal configuration as shown in FIG. 32, which is the same as that of the first embodiment. The AIT monitoring unit 3231 is different in that it reads out an AIT file separately recorded in the secondary storage unit 1307, instead of obtaining an AIT multiplexed in an MPEG-2 transport stream read out from the secondary storage unit 1307 by filtering such AIT. The AIT monitoring unit 3231 compares the AIT corresponding to the present media time with the media time 3621 in the AIT information management table, acquires the AIT file name that corresponds to the present media time, and reads out the actual AIT file. The media time progresses, and when a time is reached in which a different AIT should be referred to, a new AIT is read out. In other words, this is equivalent to a version upgrade of the AIT. Therefore, a valid period of the AIT of a current version runs from a valid start media time of that AIT until the valid start media time of another AIT.

The other operations are the same as those of the AIT monitoring unit 3231 of the first embodiment.

The application status management unit 3232 reads out a Java class file recorded in the secondary storage unit 1307 in a unique file system format, instead of reading out a Java program from the DSMCC section multiplexed in the MPEG-2 transport stream. The other operations are the same as those of the application status management unit in the first embodiment.

A characteristic operation of the broadcast recording and reproduction apparatus with the above configuration is described hereafter.

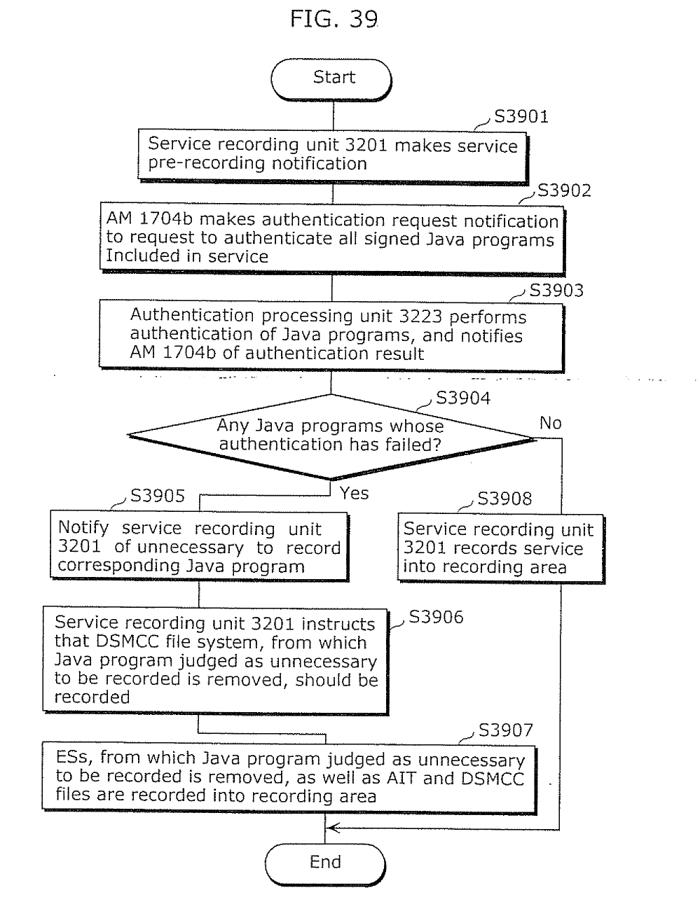

FIG. 39 is a flowchart showing an example of processes to be performed when the service recording unit 3201 of the present embodiment makes a service pre-recording notification.

The service recording unit 3201 of the recording manager 1704h makes a service pre-recording notification to the AM 1704b (S3901).

The AM 1704b makes an authentication request notification to the security manager 1704s to request to authenticate all signed lava programs included in the service (S3902).

The authentication processing unit 3223 of the security manager 1704s performs authentication of the file system lower than the “/” directory of the Java programs, and notifies the AM 1704b of the authentication result (S3903).

When the security manager 1704s notifies the failure of authenticating a Java program (S3904), the AM 1704b notifies the service recording unit 3201 of the recording manager 1704h of the unnecessity to record the Java program (S3905).

When notified of the unnecessity to record the Java program, the service recording unit 3201 of the recording manager 1704h instructs that the DSMCC file system, from which the Java program judged as unnecessary to be recorded as a result of the notification indicating the unnecessity to record the Java program is deleted, should be recorded into the recording area 1504 after converting the DSMCC file system into a file format unique to the recording area 1504, which is in turn unique to the a terminal (S3906). Accordingly, all ESs, from which the Java program judged as unnecessary to be recorded is removed, as well as AIT and DSMCC files that make up a desired channel are recorded into the recording area 1504 (S3907).

Meanwhile, in the case where the security manager 1704s notifies the success of authenticating the lava programs (S3904), the AM 1704b notifies the service recording unit of the recording manager 1704h of the necessity to record the lava programs, and the service recording unit 3201 of the recording manager 1704h records the whole service included in the broadcast wave into the secondary storage unit 1307 (S3908).

As described above, it is possible to record, into the recording area 1504, a service obtained by removing, from the service included in the broadcast wave, the Java program judged as unnecessary to be recorded.

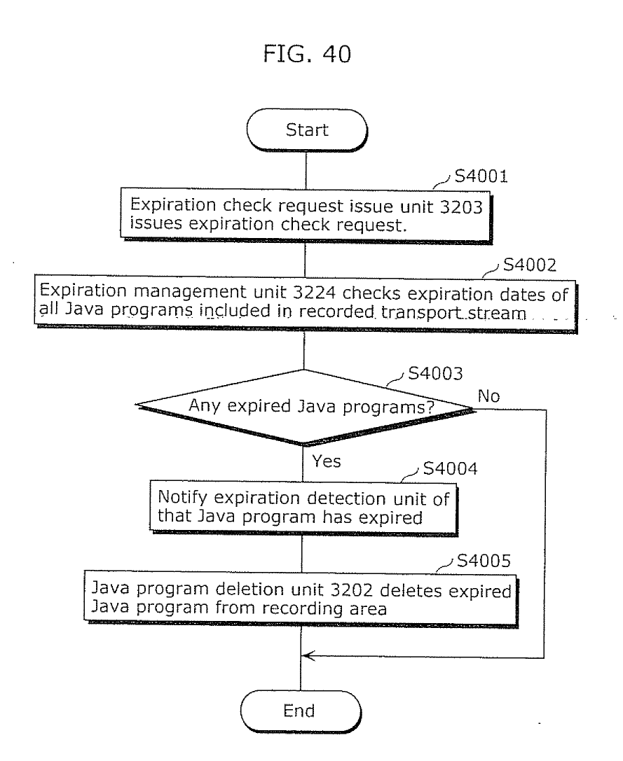

FIG. 40 is a flowchart showing an example of processes to be performed when the expiration check request issue unit 3203 in the present embodiment issues an expiration check request.

When the expiration check request issue unit 3203 of the recording manager 1704h issues an expiration check request (S4001), the expiration management unit 3224 of the security manager 1704s checks the expiration dates of all Java programs included in the service in the already recorded MPEG transport stream. More specifically, the expiration management unit 3224 compares the current time with the expiration dates of all the Java programs held in the expiration management table (S4002).

Then, in the case where the current time has passed the expiration date of any of the Java programs (S4003), the expiration management unit 3224 specifies the Java program identifier, record identifier, and section identification PID of the Java program, with reference to the expiration management table, and notifies the Java program deletion unit of the recording manager of the fact that the Java program has expired (S4004).

When notified of the expiration of the Java program, the program deletion unit 3202 of the recording manager 1704h deletes such Java program from the recording area (S4005).

Meanwhile, in the case where the current time has passed the expiration date of none of the Java programs (S4003), the expiration management unit 3224 ends the processing without performing anything.

As described above, it is possible to delete the expired Java program from the recording area.

Furthermore, in the case where the recording of all Java programs included in the service is not necessary at the time of service recording, the AIT in such service is not to be recorded.

Meanwhile, in the case where all Java programs included in the service are expired Java programs when the expiration check request issue unit 3203 issues an expiration check request, the AIT in such service is to be deleted.

As described above, according to the present embodiment, by not recording a Java program with an expired X.509 certificate into the secondary storage unit 1307 at the time of recording a service or by deleting, from a recording area, such Java program with an expired X.509 certificate in a service already recorded in the recording area, it becomes possible to make an effective use of a recording area by reducing wasteful use of a recording area, which is caused by recording a Java program to be no longer activated. Furthermore, by regularly checking the expiration date of the certificate of a Java program, it becomes possible to reduce the waste of authenticating a Java program with an expired certificate at the time of activating the Java program, and to shorten the time required to activate the Java program.

Some of the embodiments described above indicate embodiments of the present invention, but other embodiments can be implemented as long as the objects of the present invention are achieved.

In the embodiments, a configuration for a cable system has been shown, but the present invention can be applied independent of the type of broadcast system. For example, the present invention can easily be applied to a satellite system, a terrestrial system, or a TV show distribution system that uses an IP network. In addition, as the present invention has no direct relationship with the differences between each broadcast system, the present invention can be applied to an arbitrary transmission medium regardless of the broadcast system. The present invention is also applicable regardless of whether the system is a wired or wireless system.

The AV decoder does not necessarily have to decode video and audio at the same time. The present invention can be implemented even if the AV decoder is configured as separate video and audio decoders. In addition, the AV decoder may have a decoding function for data such as closed captioning and the like without any interference. The audio signal and video signal decoded by the AV decoder may be encoded at any stage up until being stored in the recording area 1504.

In the embodiments, an example is given in which an adapter that controls conditional access system is employed, but the adapter is not necessarily required for the implementation of the present invention. The adapter may be of any format, and a configuration without the adapter is also possible. In such a case, in FIG. 15, the MPEG-2 transport stream from the tuner is inputted directly into the TS decoder. The present invention is applicable is such a case as well. In addition, descrambling of the MPEG-2 transport stream by the adapter does not necessarily have to be carried out before the TS decoder. A configuration in which the adapter is in an arbitrary position and is used to descramble the MPEG-2 transport stream is easily implementable, and the present invention is applicable in such a case as well.

Regarding an encoding format into which the AV encoder encodes the audio signal and video signal, an arbitrary format is acceptable. The present invention is applicable regardless of the encoding format.

A multiplexing format of the multiplexer may also be an arbitrary format. The present invention is applicable regardless of the multiplexing format.

The display and the speaker may be contained within the broadcast recording and reproduction apparatus, or an external display and speaker may be connected to the broadcast recording and reproduction apparatus. The present invention is applicable regardless of the location and number of displays and speakers.

The present invention can be implemented even with a system in which the CPU itself performs multiple processes, which are all or some of TS decoding, AV decoding, AV encoding, and multiplexing.

As a format for recording the service, the MPEG-2 transport stream can also be recorded directly into the recording area after being outputted from the tuner, without going through the TS decoder; or, the format of the MPEG-2 transport stream from the tuner can be converted, by installing a translator that converts the format of the MPEG-2 transport stream, and recorded into the recording area. The present invention can be implemented regardless of the service recording method.

Some of the Java virtual machines translate the bytecode into an executable form which can be interpreted by the CPU and pass the resultant to the CPU, which executes it; the present invention is applicable in such a case as well.

The above embodiments describe a method for implementation regarding the AIT in which the transport stream is obtained from In-band; however, the method for referring to a Java program which the AM shall execute does not solely depend on the AIT. In OCAP, which is assumed to be used by the United States cable system, an XAIT, which describes reference information of an application program in the OOB denoted in FIG. 3, is used. In addition, methods such as starting a program already recorded in the ROM, starting a program downloaded and recorded in the secondary storage unit, and so on can be considered.

An arbitrary method is acceptable as a method for recording the DSMCC file system and the AIT file.

The present invention can be implemented even if a method in which the AIT section is filtered and acquired from the MPEG-2 transport stream and a method in which the DSMCC section is recorded in a file in a unique format, are combined. In addition, the present invention can be implemented even if a method in which the DSMCC section is filtered and acquired from the MPEG-2 transport stream and a method in which the AIT section is recorded in a file in a unique format, are combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A recording and reproduction apparatus and a recording and reproduction method according to the present invention can be applied in the consumer electronics industry as an apparatus for recording and reproducing a broadcast. For example, the present invention is applicable to cable STB, digital TV, and the like. Furthermore, the present invention is also applicable in devices with a broadcast receiving function, such as, for example, a cellular phone device and the like.

What is claimed is:

1. A broadcast recording and reproduction apparatus that receives a broadcast wave, which includes video information, audio information, an application program, and a certificate corresponding to the application program, and records and reproduces the received broadcast wave, said apparatus comprising:
a recording unit operable to record, into a recording area, the video information, the audio information, and the application program included in the received broadcast wave;
an authentication unit operable to authenticate the application program included in the broadcast wave, using the certificate corresponding to the application program;
an expiration date management unit operable to hold an expiration date of the certificate corresponding to the application program included in the broadcast wave, and to compare a current time with the expiration date of the certificate corresponding to the application program;
an application deletion unit operable to delete, from the recording area, the application program recorded in the recording area, in the case where a result of the comparison performed by said expiration date management unit indicates that the current time has passed the expiration date of the certificate corresponding to the application program; and
a broadcast wave reproduction unit operable to reproduce the video information, the audio information, and the application program included in the broadcast wave recorded in the recording area.

2. The broadcast recording and reproduction apparatus according to claim 1,
wherein said recording unit is operable to record, into the recording area, the video information and the audio information included in the broadcast wave, in the case where a result of the authentication performed by said authentication unit indicates failure.

3. The broadcast recording and reproduction apparatus according to claim 1,
wherein said recording unit includes:
a first recording control unit operable to record, into a recording area of a first recording medium, the video information, the audio information, and the application program included in the received broadcast wave; and
a second recording control unit operable to dub, onto a recording area of a second recording medium, the video information, the audio information, and the application program recorded in the recording area of the first recording medium, the second recording medium being different from the first recording medium,
wherein in the case where the expiration date of the certificate, held by said expiration date management unit, corresponding to the application program to be dubbed has passed,
said second recording control unit is operable to dub, onto the recording area of the second recording medium, the video information and the audio information out of the video information, the audio information, and the application program to be dubbed, which are recorded in the recording area of the first recording medium.

4. The broadcast recording and reproduction apparatus according to claim 3,
wherein in the case where the expiration date of the certificate, held by said expiration date management unit, corresponding to the application program to be dubbed has passed,
said application deletion unit is operable to delete the application program to be dubbed, which is recorded in the recording area of the first recording medium.

5. The broadcast recording and reproduction apparatus according to claim 1,
wherein said expiration date management unit is operable to:
hold the expiration date of the certificate corresponding to the application program included in the broadcast wave, when the application program included in the broadcast wave is recorded; and
compare the current time with the held expiration date of the certificate corresponding to the application program at regular time intervals.

6. The broadcast recording and reproduction apparatus according to claim 1,
wherein said expiration date management unit is operable to:
hold the expiration date of the certificate corresponding to the application program included in the broadcast wave, when the broadcast wave is recorded; and
perform the comparison in the case where there is not enough free space in the recording area.
